(19) United States
(12) Patent Application Publication
(10) Pub. No.: US 2026/0184942 A1
(43) Pub. Date: Jul. 2, 2026

(54) ALTERNATIVE SOLVENT/BINDER SLURRY COMPOSITIONS FOR MANUFATURE OF LITHIUM-ION BATTERY ELECTRODES

(71) Applicant: Propriety Inc., Amherst, MA (US)

(72) Inventor: DERRICK S. MAXWELL

(73) Assignee: Propriety Inc., Amherst, MA (US)

(21) Appl. No.: 19/128,041

(22) PCT Filed: Nov. 7, 2023
(86) PCT No.: PCT/US2023/036913

§ 371 Date: May 7, 2025

Related U.S. Application Data
(60) Provisional application No. 63/423,792, filed on Nov. 8, 2022.

(51) Int. Cl. C09D 5/24; C09D 5/02; C09D 7/20; C09D 7/61; C09D 7/80; C09D 109/06; C09D 127/16; C09D 133/02; C09D 139/06; H01M 4/04; H01M 4/1391

(52) U.S. Cl. CPC C09D 5/24; C09D 5/022; C09D 5/028; C09D 7/20; C09D 7/61; C09D 7/80; C09D 109/06; C09D 127/16; C09D 133/02; C09D 139/06; H01M 4/0404; H01M 4/0435; H01M 4/1391

(57) ABSTRACT

The present disclosure relates to the use of non-toxic or alternative solvents and solvent/binder packages in lithium-ion battery electrode manufacturing. In particular, the invention provides compositions, and methods of making, that are safer and greener alternatives to n-methyl-2-pyrrolidone (NMP) for lithium-ion battery electrode manufacturing and processing. The invention includes processing methods and material selections to enable stable and well-dispersed cathode slurries as well as describes compositions of binder packages that are compatible with alternative solvents.

### CROSS-REFERENCE TO RELATED APPLICATIONS

This application claims priority to, and the benefit of, U.S. Provisional Application No. 63/423,792, filed Nov. 8, 2022, the content of which is incorporated by reference herein in its entirety.

### TECHNICAL FIELD

The present disclosure generally relates to lithium-ion battery electrode manufacturing, and, in particular, the use of alternative solvents for slurry manufacture of lithium-ion battery electrodes and methods of making the same.

### BACKGROUND

Since their commercial debut in 1991, lithium-ion batteries have become ubiquitous in consumer devices ranging from portable electronics to electric vehicle propulsion and electrical grid storage to facilitate adoption of renewable energy storage. It is projected that between 2020 and 2030, the global demand for lithium-ion batteries will increase elevenfold. As a result of this growth, lithium-ion battery production is expected to increase as well, as the demand for lithium-ion batteries for electric vehicles alone is projected to increase by 1600% by 2030 over 2020 levels of gigawatt hours (GWh).

Although different cell formats may be used in lithium-ion batteries, there is not a large difference among the inner mechanisms for a specific chemistry. A lithium-ion cell generally has four essential components: a cathode coated on an aluminum current collector, an anode coated on a copper current collector, a microporous separator, and an electrolyte filled within the pores. Anodes and cathodes are made by dispersion or slurry, in which the solvents, active materials, conductive carbon additive, and binder are mixed together uniformly, coated onto the current collectors, and dried to form a consolidated electrode film. In industry, the anodes and cathodes are made by coating both sides of the metal foils to give double-sided electrodes.

The lithium-ion battery subcomponents and their manufacture comprise a variety of raw materials including, styrene butadiene rubber and carboxymethyl cellulose as anode binders, fluoropolymers and acrylate latexes, as cathode binders, and N-methyl-2-pyrrolidone (NMP) as a cathode processing aide. NMP is used in large quantities at the production level for lithium-ion battery electrodes. NMP is a known teratogen with strict exposure limitations. Safety and exposure controls related to NMP use at the manufacturing level necessitates costly engineering controls and procedures to reduce emissions and exposures. As a result, there is a desire in the battery industry to move away from NMP-based processes toward water-based solvents, however this poses several technical challenges, and so far, the use of water for cathode slurry manufacturing has not succeeded commercially. Accordingly, there is a need for non-toxic or alternative solvents and solvent/binder compositions used for lithium-ion battery manufacture.

### SUMMARY

The present disclosure relates to the use of non-toxic or alternative solvents and solvent/binder packages in lithium-ion battery electrode manufacturing. In particular, the invention provides compositions of, and methods of making, safer and greener alternatives to n-methyl-2-pyrrolidone (NMP) for lithium-ion battery electrode manufacturing and processing.

As disclosed herein, the invention provides methods for preparing a cathode slurry using alternative solvent/binder package compositions disclosed herein. The invention also provides methods for manufacturing lithium-ion battery electrodes using the alternative solvents and/or alternative solvent/binder package compositions of the present invention. The invention provides methods for manufacturing a lithium-ion battery electrode using the alternative solvent/binder packages of the invention, and it also provides lithium-ion cells using the alternative solvent/binder packages.

For example, the invention provides alternative solvents such as 1,3-propanediol (PDO), in conjunction with binders to form alternative solvent/binder packages for manufacture of lithium-ion battery electrodes. In exemplary embodiments, the invention provides for using 1,3-propanediol (PDO) as the primary solvent in lithium-ion battery manufacturing. PDO is a well-known, safe-to-use solvent in the cosmetics industry. PDO has not been utilized in any capacity within the lithium-ion battery industry to the inventor's knowledge.

In one aspect, the invention provides cathode slurry compositions. The cathode slurry compositions of the invention comprise one or more solvents, a conductive additive, a lithium-containing cathode active material (CAM), one or more solvent-soluble binders, and nanoparticles formed from a solvent-insoluble, discrete binder, wherein the one or more solvent soluble binders and the nanoparticles are dispersed within the one or more solvents.

The one or more solvents are alternative solvents to n-methyl-2-pyrrolidone (NMP) and are selected from the group consisting of 1,3-propanediol (PDO), dimethyl sulfoxide (DMSO), dimethylformamide (DMF), dihydrolevoglucosenone (Cyrene), N,N′-dimethylpropyleneurea (DMPU), γ-valerolactone (GVL), 1,2-propanediol (propylene glycol or PG), 1,2-butanediol (BDO), 1,3-butanediol (butylene glycol or BG), 1,2-hexanediol (HDO), triethyl phosphate (TEP), ethyl acetate, propyl acetate, 1-butanol, isobutanol, ethanol, anisole, dimethyl carbonate (DMC), and propylene carbonate (PC).

As disclosed in more detail herein, in some embodiments of the composition, the one or more solvent-soluble binders are selected from the group consisting of polyvinylpyrrolidone (PVP), polyacrylic acid (PAA), polymethyl methacrylate (PMMA), polymethacrylic acid (PMA), polyvinyl alcohol (PVA), and a carboxyl methyl cellulose (CMC) derivative.

For example, in some embodiments of the cathode slurry compositions, the one or more mixtures comprise a first mixture comprising the one or more solvents, the one or more solvent-soluble binders, and the conductive additive; and a second mixture comprising the one or more solvents, the one or more solvent-soluble binders, the lithium-containing cathode active material (CAM), and nanoparticles formed from the solvent-insoluble, discrete binder, wherein the solvent-soluble binder and the nanoparticles are dispersed within the one or more solvents. The two mixtures are combined to prepare the cathode slurry composition. In some embodiments, the first mixture and the second mixture are prepared as discrete mixtures and then combined. In other embodiments, the first mixture and the second mixture are prepared as a single mixture with all components.

In some embodiments of the compositions, the one or more solvent-soluble binders in the first mixture are the same as the one or more solvent-soluble binders in the second mixture. In other embodiments of the slurry compositions, the one or more solvent-soluble binders in the first mixture are different than the one or more solvent-soluble binders in the second mixture. In some embodiments, the one or more solvents used in the first mixture are the same as the one or more solvents used in the second mixture. In some embodiments, the one or more solvents used in the first mixture are different than the one or more solvents used in the second mixture.

In some embodiments, the one or more solvents comprises 1,3-propanediol (PDO). In which case, for example, the solvent-soluble binder comprises polyvinylpyrrolidone (PVP) or polyacrylic acid (PAA), and the solvent-insoluble discrete binder comprises styrene-butadiene rubber (SBR) or polyvinylidene fluoride (PVDF), wherein the solvent-insoluble discrete binder forms nanoparticles dispersed in the PDO. Further, in some embodiments of the slurry composition, the solvent-soluble binder is a combination of PAA and PVP, and the solvent-insoluble discrete binder is a combination of SBR and PVDF.

In some embodiments of the slurry composition, the cathode active material (CAM) is a lithium intercalating or lithium alloying material. In some embodiments of the slurry composition, the CAM comprises one or more of a lithium intercalating material, lithium nickel cobalt manganese oxide (NCM), lithium nickel cobalt aluminum oxide (NCA), lithium cobalt oxide (LCO), lithium manganese oxide (LMO), lithium iron phosphate (LFP), and lithium iron manganese phosphate (LMFP). In some embodiments of the slurry composition, the conductive additive is one or more of amorphous carbon, graphene, carbon nanotubes, porous carbon, and carbon black.

In another aspect, the invention provides methods for preparing a cathode slurry composition. The method includes the steps of preparing one or more mixtures, wherein the one or more mixtures comprise one or more solvents; one or more solvent-soluble binders; a conductive additive; a cathode active material (CAM); and a solvent-insoluble discrete binder, to form a homogenous cathode slurry composition.

In some embodiments, preparing the one or more mixtures comprises preparing a first mixture comprising the one or more solvents and the one or more solvent-soluble binders to form a first binder package, and the conductive additive. Further, the method includes preparing a second mixture comprising the one or more solvents and the one or more solvent-soluble binders to form a second binder package, the cathode active material (CAM), and the solvent-insoluble binder. The method includes combining the first mixture with the second mixture to form a homogenous cathode slurry composition. In some embodiments, the first mixture and the second mixture are prepared as discrete mixtures and then combined. In other embodiments, the first mixture and the second mixture are prepared as a single mixture.

In some embodiments of the method, the one or more solvent-soluble binders in the first mixture are the same as the one or more solvent-soluble binders in the second mixture. In other embodiments of the method, the one or more solvent-soluble binders in the first mixture are different than the one or more solvent-soluble binders in the second mixture. In some embodiments, the one or more solvents used in the first mixture are the same as the one or more solvents used in the second mixture. In some embodiments, the one or more solvents used in the first mixture are different than the one or more solvents used in the second mixture. In some embodiments, the first binder package and second binder package contain components of varying molecular weight such that the first binder package and the second binder package vary in molecular weight.

The one or more solvents are alternative solvents to n-methyl-2-pyrrolidone (NMP) and are selected from the group consisting of 1,3-propanediol (PDO), dimethyl sulfoxide (DMSO), dimethylformamide (DMF), dihydrolevoglucosenone (Cyrene), N,N′-dimethylpropyleneurea (DMPU), γ-valerolactone (GVL), 1,2-propanediol (propylene glycol or PG), 1,2-butanediol (BDO), 1,3-butanediol (butylene glycol or BG), 1,2-hexanediol (HDO), triethyl phosphate (TEP), ethyl acetate, propyl acetate, 1-butanol, isobutanol, ethanol, anisole, dimethyl carbonate (DMC), and propylene carbonate (PC).

In some embodiments of the method, the one or more solvent-soluble binders are selected from the group consisting of polyvinylpyrrolidone (PVP), polyacrylic acid (PAA), polymethyl methacrylate (PMMA), polymethacrylic acid (PMA), polyvinyl alcohol (PVA), and a carboxyl methyl cellulose (CMC) derivative.

In exemplary embodiments, the solvent comprises 1,3-propanediol (PDO). In which case, the one or more solvent-soluble binders comprise polyvinylpyrrolidone (PVP) or polyacrylic acid (PAA), and the solvent-insoluble discrete binder comprises styrene-butadiene rubber (SBR) or polyvinylidene fluoride (PVDF), wherein the solvent-insoluble discrete binder forms nanoparticles dispersed in the PDO, in some embodiments. Further, in some embodiments, the solvent-soluble binder is a combination of PAA and PVP, and the solvent-insoluble discrete binder is a combination of SBR and PVDF.

In some embodiments of the method, the cathode active material (CAM) is a lithium intercalating or lithium alloying material. In some embodiments, the CAM comprises one or more of a lithium intercalating material, lithium nickel cobalt manganese oxide (NCM), lithium nickel cobalt aluminum oxide (NCA), lithium cobalt oxide (LCO), lithium manganese oxide (LMO), lithium iron phosphate (LFP), and lithium iron manganese phosphate (LMFP).

In some embodiments, the conductive additive is one or more of amorphous carbon, graphene, carbon nanotubes, porous carbon, and carbon black.

In another aspect, the invention provides methods for manufacturing a lithium-ion battery electrode. The method includes preparing one or more mixtures comprising one or more solvents; one or more solvent-soluble binders; a conductive additive; a cathode active material (CAM); and a solvent-insoluble discrete binder, to form a homogenous cathode slurry composition. The method further includes coating the cathode slurry onto a current collector, and drying and calendaring to a target thickness and porosity upon drying to thereby fabricate a lithium-ion battery electrode.

In some embodiments, preparing the one of more mixtures includes preparing a first mixture comprising the one or more solvents and the one or more solvent-soluble binders to form a first binder package, and the conductive additive. The method further includes preparing a second mixture comprising the one or more solvents and the one or more solvent-soluble second binders to form a second binder package, the cathode active material (CAM), and the solvent-insoluble binder package. The method includes combining the first mixture with the second mixture to form a homogenous cathode slurry composition. In some embodiments, the first mixture and the second mixture are prepared as discrete mixtures and then combined. In other embodiments, the first mixture and the second mixture are prepared as a single mixture.

In some embodiments of the method, the one or more solvent-soluble binders in the first mixture are the same as the one or more solvent-soluble binders in the second mixture. In some embodiments, the one or more solvent-soluble binders in the first mixture are different than the one or more solvent-soluble binders in the second mixture. In some embodiments, the one or more solvents used in the first mixture are the same as the one or more solvents used in the second mixture. In some embodiments, the one or more solvents used in the first mixture are different than the one or more solvents used in the second mixture. In some embodiments of the method, the first binder package and second binder package contain components of varying molecular weight such that the first binder package and the second binder package vary in molecular weight.

The one or more solvents are alternative solvents to n-methyl-2-pyrrolidone (NMP) and are selected from the group consisting of 1,3-propanediol (PDO), dimethyl sulfoxide (DMSO), dimethylformamide (DMF), dihydrolevoglucosenone (Cyrene), N,N′-dimethylpropyleneurea (DMPU), γ-valerolactone (GVL), 1,2-propanediol (propylene glycol or PG), 1,2-butanediol (BDO), 1,3-butanediol (butylene glycol or BG), 1,2-hexanediol (HDO), triethyl phosphate (TEP), ethyl acetate, propyl acetate, 1-butanol, isobutanol, ethanol, anisole, dimethyl carbonate (DMC), and propylene carbonate (PC).

In some embodiments of the method, the one or more solvent-soluble binders are selected from the group consisting of polyvinylpyrrolidone (PVP), polyacrylic acid (PAA), polymethyl methacrylate (PMMA), polymethacrylic acid (PMA), polyvinyl alcohol (PVA), and a carboxyl methyl cellulose (CMC) derivative.

In exemplary embodiments of the method, the solvent comprises 1,3-propanediol (PDO). In which case, in some embodiments, the solvent-soluble binder comprises polyvinylpyrrolidone (PVP) or polyacrylic acid (PAA), and the solvent-insoluble discrete binder comprises styrene-butadiene rubber (SBR) or polyvinylidene fluoride (PVDF), wherein the solvent-insoluble discrete binder forms nanoparticles dispersed in the PDO. Further, in some embodiments, the solvent-soluble binder is a combination of PAA and PVP, and the solvent-insoluble discrete binder is a combination of SBR and PVDF.

In some embodiments of the method, the cathode active material (CAM) is a lithium intercalating or lithium alloying material. In some embodiments, the CAM comprises one or more of a lithium intercalating material, lithium nickel cobalt manganese oxide (NCM), lithium nickel cobalt aluminum oxide (NCA), lithium cobalt oxide (LCO), lithium manganese oxide (LMO), lithium iron phosphate (LFP), and lithium iron manganese phosphate (LMFP).

In some embodiments of the method, the conductive additive is one or more of amorphous carbon, graphene, carbon nanotubes, porous carbon, and carbon black.

In another aspect, the invention provides lithium-ion cells comprising a cathode being formed from an alternative solvent slurry coated on a conductive substrate, wherein the alternative solvent is not N-methyl-2-pyrrolidone (NMP). The slurry comprises one or more mixtures comprising one or more alternative solvents. The one or more alternative solvents are alternative solvents to n-methyl-2-pyrrolidone (NMP) and are selected from the group consisting of 1,3-propanediol (PDO), dimethyl sulfoxide (DMSO), dimethylformamide (DMF), dihydrolevoglucosenone (Cyrene), N,N′-dimethylpropyleneurea (DMPU), γ-valerolactone (GVL), 1,2-propanediol (propylene glycol or PG), 1,2-butanediol (BDO), 1,3-butanediol (butylene glycol or BG), 1,2-hexanediol (HDO), triethyl phosphate (TEP), ethyl acetate, propyl acetate, 1-butanol, isobutanol, ethanol, anisole, dimethyl carbonate (DMC), and propylene carbonate (PC).

The slurry further comprises a conductive additive, a lithium-containing, cathode active material (CAM), one or more solvent-soluble binders, and nanoparticles formed from a solvent-insoluble, discrete binder, wherein the one or more solvent soluble binders and the nanoparticles are dispersed within the one or more solvents.

In some embodiments of the lithium-ion cell, the one or more solvent-soluble binders is selected from the group consisting of polyvinylpyrrolidone (PVP), polyacrylic acid (PAA), polymethyl methacrylate (PMMA), polymethacrylic acid (PMA), polyvinyl alcohol (PVA), and a carboxyl methyl cellulose (CMC) derivative.

In some embodiments, the alternative solvent is 1,3-propanediol (PDO). For example, the alternative solvent slurry comprises a PDO solvent, a lithiated cathode active material, a conductive additive, and a polyvinylpyrrolidone (PVP) binder dispersed in the PDO solvent, an anode, a separator positioned between the cathode and the anode, and an electrolyte that touches the separator, anode, and cathode, in some embodiments. In some embodiments, the alternative solvent slurry comprises a PDO solvent, a lithiated cathode active material, a conductive additive, and a polyacrylic acid (PAA) binder dispersed in the PDO solvent, an anode, a separator positioned between the cathode and the anode, and an electrolyte that touches the separator, anode, and cathode. Further, in some embodiments of the lithium-ion cell, the anode active material comprises one or more of lithium metal, graphite, graphene, lithium titanium oxide (LTO), silicon, a silicon oxide, or a carbon-silicon composite. In some embodiments, the separator comprises one or more of polyethylene (PE), a polyethylene derivative, non-woven polymeric polyimide (PI) derivatives, Teflon (PTFE) derivatives, glass fiber (GF), and/or a ceramic coated variations of PE, PI, PTFE, and GF. In some embodiments, the electrolyte comprises a mixture of ethylene carbonate (EC), dimethyl carbonate (DMC), and a LiPF₆ salt.

In some embodiments of the lithium-ion cell, the one or more mixtures includes a first mixture comprising the one or more alternative solvents, the one or more solvent-soluble binders, and the conductive additive, and a second mixture comprising the one or more alternative solvents, the one or more solvent-soluble binders, the lithium-containing cathode active material (CAM), and nanoparticles formed from the solvent-insoluble, discrete binder. In some embodiments, the first mixture and the second mixture are prepared as discrete mixtures and then combined. In other embodiments, the first mixture and the second mixture are prepared as a single mixture with all components.

In some embodiments, the one or more solvent-soluble binders in the first mixtures is the same as the one or more solvent-soluble binders in the second mixture. In other embodiments, the one or more solvent-soluble binders in the first mixture is different than the one or more solvent-soluble binders in the second mixture.

In some embodiments, the one or more solvents used in the first mixture are the same as the one or more solvents used in the second mixture. In some embodiments, the one or more solvents used in the first mixture are different than the one or more solvents used in the second mixture.

In some embodiments of the method, the cathode active material (CAM) is a lithium intercalating or lithium alloying material. In some embodiments, the CAM comprises one or more of a lithium intercalating material, lithium nickel cobalt manganese oxide (NCM), lithium nickel cobalt aluminum oxide (NCA), lithium cobalt oxide (LCO), lithium manganese oxide (LMO), lithium iron phosphate (LFP), and lithium iron manganese phosphate (LMFP).

In some embodiments, the conductive additive is one or more of amorphous carbon, graphene, carbon nanotubes, porous carbon, and carbon black.

In some embodiments, the first binder package and second binder package contain components of varying molecular weight such that the first binder package and the second binder package vary in molecular weight.

### BRIEF DESCRIPTION OF THE DRAWINGS

FIG. 1 illustrates a block diagram of a method of preparing a homogenous cathode slurry composition according to one embodiment of the invention.

FIG. 2 illustrates a block diagram of a method for manufacturing a lithium-ion battery electrode according to one embodiment of the invention.

FIG. 3 illustrates a block diagram of a process for manufacturing a lithium-ion battery electrode in which PDO is used as the alternative solvent, and further slurry mixing, coating, and drying which results in a completed electrode according to one embodiment of the invention.

### DETAILED DESCRIPTION

The present disclosure relates to the use of non-toxic or alternative solvents and solvent/binder packages in lithium-ion battery electrode manufacturing. In particular, the invention provides compositions, and methods of making, that are safer and greener alternatives to n-methyl-2-pyrrolidone (NMP) for lithium-ion battery electrode manufacturing and processing.

As noted herein, there is a desire in the battery industry to move away from NMP-based processes toward water-based solvents, however this poses several technical challenges. There are obvious safety improvements when considering water as the primary solvent, but so far, the use of water for cathode slurry manufacturing has not succeeded commercially.

The invention addresses these problems by providing cathode slurry compositions using alternative solvents to the n-methyl-2-pyrrolidone (NMP) that is used in conventional, industry-typical processes. As disclosed herein, the invention includes methods of processing, and material selections, to enable stable and well-dispersed cathode slurries. In particular, the disclosure provides compositions of binder packages that are compatible with the alternative solvents listed which are non-obvious to those skilled in the art. As disclosed herein, the invention provides alternative solvents and solvent/binder package compositions for use in lithium-ion battery electrode manufacturing. The invention provides methods for preparing a cathode slurry using the alternative solvent/binder package compositions. The invention also provides methods for manufacturing lithium-ion battery electrodes using the alternative solvents and/or alternative solvent/binder package compositions of the present invention.

In exemplary embodiments, the disclosure provides for using 1,3-propanediol (PDO) as the primary solvent in lithium-ion battery electrode manufacturing. As with the alternative solvents and solvent/binder compositions disclosed herein, 1,3-propanediol is utilized as a safer and more cost-effective solvent than the n-methyl-2-pyrrolidone (NMP) used in conventional lithium-ion battery manufacture.

The use of alternative solvents, for example 1,3-propanediol PDO, as the main solvent in solvent/binder packages in cathode manufacturing avoids many of the issues that are found with typical NMP/binder packages and recent water-based alternatives. For example, the disclosed alternative solvent/binder packages help to prevent slurry gelation, and they represent an improvement in processing and electrode composition to increase relative content of active and conductive materials. The alternative solvent binder package compositions of the invention also prevent current collector corrosion issues present in water-based cathode approaches. Utilization of alternative solvents as the main solvent platform in cathode manufacturing at production scale is estimated to decrease materials cost by as much as 50% while also dramatically decreasing risks associated with human health hazards and environmental concerns.

As disclosed herein, safer and greener alternatives to n-methyl-2-pyrrolidone (NMP) as determined for lithium-ion battery electrode manufacturing and processing were evaluated. For example, 1,3-propanediol (PDO), is a well-known, safe-to-use solvent in the cosmetics industry. PDO has not been utilized in any capacity within the lithium-ion battery industry to the inventor's knowledge. PDO is typically regarded as a safe chemical. Several other solvents were identified and evaluated as replacement candidates for the solvent/binder packages of the invention due to low toxicity and similar physical characteristics that are suitable for cathode slurry manufacture.

It was surprisingly found by the present invention that many of the issues observed with water-based cathode slurry may be addressed with alternative solvents, such as 1,3-propanediol (PDO), 1,2-propanediol (propylene glycol or PG), 1,2-butanediol (BDO), 1,3-butanediol (butylene glycol or BG), 1,2-hexanediol (HDO), ethanol, isopropanol, anisole (methoxybenzene), dimethyl carbonate (DMC), and propylene carbonate (PC), while still significantly improving upon the safety issues associated with NMP use.

Further, alternative solvents can be significantly more cost effective than NMP due to low cost at scale. For example, 1,3-propanediol and propylene glycol are generally less than half the cost of NMP at scale. 1,3-propanediol and propylene glycol are also currently already utilized by several large industries (pharma, cosmetics, food, etc.). In addition to simple cost savings, the incorporation of alternative solvents, such as 1,3-propanediol, into typical cathode slurry manufacturing processes may present few new implementation challenges to battery manufacturers. In particular, few if any changes are required in terms of infrastructure and equipment when adopting, for example, PDO-based technology because the chemical and physical properties in terms of boiling point, flash point, and corrosivity are all similar if not better suited for slurry manufacturing than NMP.

### Alternative Solvent/Binder Package Compositions

As disclosed herein, the invention provides compositions for cathode slurries, methods for preparing slurries for lithium-ion battery electrodes, methods of preparing lithium-ion battery electrodes, and lithium-ion cells.

The current preferred and main polymer binder for lithium-ion battery cathodes is polyvinylidene fluoride (PVDF). The invention recognizes that alternative solvents, such as PDO may not dissolve PVDF, thus, the invention provides alternative binder and solvent packages to move away from the conventional NMP/PVDF package for lithium-ion battery manufacture.

For example, 1,3-propanediol can dissolve many polymers that are also water soluble, thus allowing for use of binders that are typically only achieved in water-based anodes, such as polyacrylic acid (PAA), polyvinyl alcohol (PVA), some cellulosics, and polyvinylpyrrolidone (PVP), in non-limiting examples.

Other solvents include polar solvents, with generally lower or equivalent toxicity to NMP, such as dimethyl sulfoxide (DMSO), dimethylformamide (DMF), dihydrolevoglucosenone (Cyrene), N,N′-dimethylpropyleneurea (DMPU), γ-valerolactone (GVL), 1,3-propanediol (PDO), 1,2-propanediol (propylene glycol or PG), 1,2-butanediol (BDO), 1,3-butanediol (butylene glycol or BG), 1,2-hexanediol (HDO), triethyl phosphate (TEP), ethyl acetate, propyl acetate 1-butanol, isobutanol, ethanol, isopropanol, and propylene carbonate (PC). Of the polar solvents, the following are non-toxic or of mild concern and are preferred: GVL, PDO, PG, BDO, BG, HDO, ethanol, isopropanol, and PC.

Water based anodes generally utilize a combination of dissolved carboxyl methyl cellulose and discrete styrene butadiene rubber (CMC/SBR), and it is possible to replace PVDF by replicating a similar dissolved/discrete binder package on the cathode by utilizing alternative solvents, such as those listed in Table 1 disclosed herein, or in exemplary embodiments, PDO. One primary solvent-soluble alternative that shows promise is polyacrylic acid (PAA). Another alternative that shows promise is polyvinylpyrrolidone or PVP. By replacing the NMP/PVDF binder package with, for example, PDO/PAA or PDO/PVP, or other alternative, polar, non-toxic solvents paired with PAA or PVP, the safety of producing cathode slurries is greatly enhanced. The PDO/PAA or PDO/PVP may further be combined with discrete SBR particles suspended in PDO, thus replicating the dissolved/discrete binder structure of typical water-based anodes and providing an advantage over the incumbent PVDF/NMP system that does not contain a discrete binder component. A PDO-based PAA/SBR or PVP/SBR binder provides the long-range cohesive benefits of dissolved polymer structure as well as short-range point-to-point binding mechanisms from the discrete SBR particles, which is lacking when only utilizing an NMP/PVDF binder system for lithium-ion battery cathodes. Battery grade PVDF is also generally expensive, and other off-the-shelf polymers may be utilized at a lower cost in alternative-solvent based slurries. For example, polyacrylic acid is up to ten times less expensive than PVDF and is soluble in many polar non-toxic solvents.

The invention recognizes that PVDF may be preferred as the main polymer of binder in industry due to convenience, availability, and familiarity, and not purely due to superior cost or performance considerations. There is significant opportunity in the market to provide an alternative binder and solvent package to move away from NMP/PVDF.

This invention exemplifies a balanced approach involving chemical properties, cost, and safety that leads to similar performance of NMP based cathodes but with the added beneficial concepts desired from the water-based binder approaches. Detailed solvent properties related to the methods and compositions of the invention have been investigated and are presented in Table 1.

In one aspect, the invention provides cathode slurry compositions using alternative solvent/binder mixtures for use in the manufacture of lithium-ion battery electrode. As discussed in more detail herein, the cathode slurry composition includes one or more solvents selected from the solvents listed in Table 1, for example, one or more solvents selected from the group consisting of: 1,3-propanediol (PDO), dimethyl sulfoxide (DMSO), dimethylformamide (DMF), dihydrolevoglucosenone (Cyrene), N,N′-dimethylpropyleneurea (DMPU), γ-valerolactone (GVL), 1,2-propanediol (propylene glycol or PG), 1,2-butanediol (BDO), 1,3-butanediol (butylene glycol or BG), 1,2-hexanediol (HDO), triethyl phosphate (TEP), ethyl acetate, propyl acetate, 1-butanol, isobutanol, ethanol, anisole, dimethyl carbonate (DMC), and propylene carbonate (PC).

The cathode slurry compositions of the invention comprise one or more solvents, a conductive additive, a lithium-containing cathode active material (CAM), one or more solvent-soluble binders, and nanoparticles formed from a solvent-insoluble, discrete binder, wherein the one or more solvent soluble binders and the nanoparticles are dispersed within the one or more solvents.

In some embodiments of the slurry composition, the one or more mixtures include a first mixture comprising the one or more solvents, the one or more solvent-soluble binders, and the conductive additive; and a second mixture comprising the one or more solvents, the one or more solvent-soluble binders, the lithium-containing cathode active material (CAM), and the nanoparticles formed from the solvent-insoluble, discrete binder, wherein the solvent soluble binder and the nanoparticles are dispersed within the one or more solvents. In some embodiments, the first mixture and the second mixture are prepared as discrete mixtures and then combined. In other embodiments, the first mixture and the second mixture are prepared as a single mixture with all components.

TABLE 1
Chemical Properties Comparison

| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|---|---|---|---|---|---|
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

The one or more alternative solvents are selected primarily based on safety improvements. Some solvents, for example PDO, also exhibit similarity in processing properties to NMP. This allows for fairly direct implementation to standard cathode production processes. For example, surface tension, boiling points, and densities of the alternative solvents may be within a similar range of values, which makes the alternative solvents similarly processable in a liquid mixing and transport process when compared to NMP.

For example, PDO notably has significantly higher viscosity. Whereas NMP viscosity is more similar to water (in other words low viscosity), PDO is a thicker fluid. The increase in viscosity from 1.65 cP of NMP to 40.8 cP of PDO at room temperature allows for an increased viscosity of the electrode slurry mixture. This is beneficial because less solvent-soluble binder content may be needed within the slurry mixture to accommodate and suspend higher density cathode active material (CAM) particles. Decreased binder content allows for higher relative content of CAM and conductive particles, which would lead to improved electrode and cell level performance due to increased conductivity and energy density.

A higher viscosity fluid approach allows for a more stable slurry composition, which also allows for increased maximum allowed processing time before settling and agglomeration can occur. If the alternative solvent viscosity requires modification (i.e. decreasing viscosity to accommodate different slurry compositions and coating conditions) one skilled in the art may incorporate any number of additional polar, non-toxic solvents as indicated in the following: GVL, ethanol, isopropanol, and propylene carbonate with viscosities of 1.8, 1.07, 2.4, and 2.531 cP at room temperature respectively.

Another alternative low-viscosity solvent with slightly increased toxicity concern may include TEP with a room temperature viscosity of 1.6 cP. Toxic or suspected toxic solvents with lower viscosity than PDO include: DMSO, DMF, Cycrene, DMPU, ethyl acetate, and propyl acetate with room temperature viscosities of 2.2, 0.92, 46, 3.32, 0.43, and 0.55 respectively. If an increase in viscosity may be beneficial, the following polar, non-toxic solvents may also be incorporated: PG, BDO, BG, and HDO with room temperature viscosities of 56, 106, 96, and 148 cP respectively.

Regarding safety, GVL, PDO, PG, BDO, BG, HDO, ethanol, isopropanol, and PC are demonstrably significantly safer solvents for human and environmental health than NMP while DMSO, DMF, cyrene, DMPU, TEP, ethyl acetate, and propyl acetate may be eligible solvent replacements for NMP but are considered toxic to a similar or slightly lesser degree than NMP. PDO, PG, BDO, BG, HDO, propyl acetate, ethanol, isopropanol, and PC are listed by the United States EPA as “Safer Choice” chemicals under the solvent category. These selected solvents pass criteria set by the EPA which generally indicate a low concern in terms of toxicity, pollution, and workplace hazard. NMP on the other hand has been identified as a solvent which is teratogenic, damaging to the reproductive system, harmful to human health via the central nervous system, is readily absorbed through the skin, and was determined to be harmful via inhalation. Another benefit of several alternative solvents are generally higher flash points (cyrene, DMPU, GVL, PDO, PG, BDO, BG, HDO, TEP, and PC of 108, 121, 96, 99, 101, 110, 121, 93, 115, and 132 degrees Celsius respectively compared to NMP of 86 degrees Celsius), thus making these alternative solvents more process and manufacturing friendly for heating and evaporation operations.

In some embodiments, various polymers may be dissolved in alternative solvents, such as a polar solvent, to provide an alternative to the typical PVDF binder used in NMP-based slurries.

In a further example, an emulsion polymerization may also be utilized, in which the host solvent is PDO or PG (not water as in regular emulsion polymerization). Monomers may be selected to be suspended in a solvent that is not miscible with the PDO or PG phase, thus constituting an “oil” phase. The oil phase containing the monomers may be agitated to form droplets of a target size, also known as micelles. With addition of free radical chemical sources, agitation, and heat, polymerization of the suspended monomers occurs within the micelles. Nanoparticle suspension of the polymer may be achieved similarly to a water-based styrene butadiene rubber (SBR), however the majority of the solvent may be PDO or PG. This suspension may be easily incorporated as a co-binder along with the solubilized polymer in PDO or PG. The invention may comprise two different polymers with the host solvent being PDO and/or PG (one emulsified polymer and one solubilized polymer). This composition may be analogized to CMC/SBR (carboxyl methyl cellulose and styrene butadiene rubber) in typical water-based anodes. As with water-based anodes, this allows for a higher degree of customization for binder packages as one can vary the amount of discrete vs solubilized binder to tune rheology and coating performance of cathode slurry. This is currently not possible with the typical PVDF/NMP system for cathode manufacture. Utilizing both a solubilized and emulsified polymer binder in PDO/PG allows for the benefits of viscosity modification from the solubilized binder and improved adhesion and flexibility of the electrode from the point-to-point connections established by the emulsified discrete polymer binder. This is a technique that can be leveraged by moving to a PDO/PG based slurry rather than an NMP with PVDF based slurry.

In another example, polyvinyl pyrrolidone (PVP) polymer can be dissolved in both PDO and NMP to make binder solutions. As disclosed herein, polyvinylpyrrolidone or PVP is also known to be soluble in several other polar solvents that are discussed in this description and noted in Table 1. The main difference, other than health/safety/cost, is processability. PVP carries higher viscosity in PDO than NMP. By simple, high-shear, overhead mixing, PVP can be easily dissolved in PDO and used as a direct binder replacement. By achieving higher relative viscosity by simply changing solvent, less polymer can be used to achieve higher viscosity slurries, which in turn leads to lower necessary solids content for stable slurries. This gives a good control over the coating parameters and rheological properties of the slurry when fabricating electrodes. Only those skilled in the art of slurry mixing and cathode coating would be able to properly leverage this widened window of processing parameters. For example, simply switching from NMP/PVP to PDO/PVP allows for lower coat weights by decreasing solids content while retaining stable slurry. This would benefit high power applications. For higher energy applications, heavier coat weights can be obtained by further decreased polymer content and increased solids content without increasing solids to the point of agglomeration and quality degradation. As disclosed herein, another primary alternative is polyacrylic acid (PAA). By replacing the NMP/PVDF combination binder package with, for example, PDO/PAA or PDO/PVP, or other alternative, polar, non-toxic solvents paired with PAA or PVP, the safety of producing cathode slurries is greatly enhanced.

There can be many more alternatives to polyvinylpyrrolidone (PVP) for the alternative solvent-based binder packages of the invention. Some early tests conducted by the inventor indicate that polyacrylic acid (PAA) is highly soluble in PDO, PG and PC, for example. Polymethyl methacrylate (PMMA), polymethacrylic acid (PMA), polyvinyl alcohol (PVA) and some cellulosic derivatives of lower molecular weight than typical carboxyl methyl cellulose (CMC) used in typical water-based anode may also be soluble in PDO, PG, and PC among other polar solvents (listed in table 1). PVDF may not be used directly with PDO, PG, BDO, BG, HDO, ethyl acetate, propyl acetate, 1-butanol, isobutanol, ethanol, isopropanol, anisole, DMC, or PC as the soluble based binder because PVDF is insoluble in these solvents, however vinylidene fluoride (VDF) monomers could be used in an emulsion polymerization process to generate a suspension of PVDF nanoparticles in the glycol solvents and other polar solvent alternatives. For example, the emulsion polymerization process could be utilized to generate PVDF or SBR nanoparticles within an alternative solvent media as well. Other examples of discrete polymers that could be generated this way include but are not limited to acrylate derivatives, polyimides/polyamides, polyurethanes, and various butadiene rubber derivatives (modified SBR classifications).

To the inventor's knowledge, there is no current effort to utilize PDO, PG, BDO, BG, HDO, TEP, ethyl acetate, propyl acetate, 1-butanol, isobutanol, ethanol, isopropanol, anisole, dimethyl carbonate (DMC) or PC as cathode slurry solvents in industry or academia. The following solvents have been utilized in prior art whether published in academic journals or demonstrated in industry: DMSO, DMF, cyrene, DMPU, and GVL, however they each carry a toxicity risk and increased cost compared to NMP and are not suitable as a complete replacement for NMP as the sole solvent used in cathode slurry production.

Most of the industry and academic-based focus is currently put into attempting to make water-based PVDF suspensions viable by adding base inhibitors and pH modifiers to the water-based binder packages, usually in the form of acids or buffer solutions. Compared to water-based slurries that are not pH-compensated, this approach yields improvement in electrochemical data in some academic applications, but it is not commercially accepted due to increased risks related to implementation complexity and lower guarantees of manufacturing success at scale. The amount of base inhibitor or pH modifier added to water-based cathode slurries requires careful and precise control, which is easy to achieve at the bench scale, but has yet to be demonstrated in pilot or production scale slurries. This approach is also highly dependent on the cathode active material (CAM) selected, and it requires implementation of online pH measurements and monitoring which is challenging in multi-ton production scale mixing equipment. There is an inherent risk to relying on pH modifiers with water-based slurries: addition of an excess of pH modifier may result in acidic conditions which are also corrosive to the materials of the slurry or the current collector and could ruin the performance of the resultant battery cells. The current state of the art in water-based slurry approaches runs the risk of becoming self-defeating in real-world manufacturing conditions. This acidification effect may be realized throughout the bulk slurry or even in localized concentrations of the slurry if mixing of the pH modifiers is not properly homogeneous, resulting in portions of slurry with pH that is too basic and portions of slurry with pH that is too acidic. Such failures at the multi-ton level of slurry production required for lithium-ion battery manufacture would result in catastrophic scrap rates and deeply harm the productivity and profitability of a large-scale business. The alternative solvent replacement strategy disclosed herein represents a significantly lower barrier to industry acceptance and utilization because the risk of pH modification is entirely circumnavigated.

Lithium hydroxide and lithium carbonate, the major surface impurities of CAM, known as residual lithium sources, are highly soluble in water. In aqueous solution, the hydronium/hydroxide equilibrium is enabled with the hydroxide provided from the residual lithium sources, thus exacerbating an issue that does not exist in traditional NMP/PVDF slurries. In a non-aqueous solution, especially those utilizing the alternative solvents provided in this invention, there is no hydronium/hydroxide equilibrium due to lack of the presence of water, and residual lithium sources are very poorly soluble in the alternative solvents provided in this invention. Therefore, a near complete avoidance of the fundamental flaw experienced with water based cathode slurries may be realized by utilizing the alternative solvents of the invention provided herein. To the inventor's knowledge, no other technology provides the benefits of the alternative solvent and binder approaches provided by this invention with regards to residual lithium compatibility.

Further, issues arise in water-based approaches simply because once water is added, it is immensely difficult to remove from the cathode with current drying processes, especially at scale once electrodes are contained on large rolls, where water diffusion is quite limited. Water retained in the cathode leads to aluminum corrosion via increased lithium hydroxide leaching and increased parasitic side reactions during battery cycling which in turn rapidly degrades battery performance.

In another example, water-based processing of high nickel content lithium nickel cobalt manganese oxide (NCM) or lithium-rich variations of CAM including NCM, also leads to decreased specific capacity of the host CAM via lithium leaching in the presence of water. This occurs in water-based cathode slurry processing as well as in the manufacture of the material prior to slurry processing. A typical processing example is described here for demonstration. In the production of high nickel content NCM and/or lithium-rich variations of CAM including NCM, the final product powder may be serially rinsed with water to purposefully dissolve and remove residual lithium sources from the surface. The rinsed powder is then thoroughly vacuum dried. These process steps are incorporated by CAM manufacturers in efforts to reduce the surface residual lithium prior to shipping the material to lithium-ion battery manufacturers so that they may have less processing difficulties as described previously. These processing steps are still not entirely successful in removing all residual lithium from the surface and only serve as a reductive measure. The alternative solvents presented in this invention provide an opportunity to enable processing of high residual lithium containing CAM during cathode slurry production. Without the need of the CAM manufacturer to first rinse with water and subsequently dry the powder, the cost of the CAM may be reduced, and the capacity of the material may be retained. The removal of these upstream processing steps can drive down the price of the CAM and ultimately decrease the cost of the lithium-ion battery cell which greatly benefits the industry-wide goal to achieve affordable lithium-ion batteries in the market.

This alternative solvent/binder package technology and approach may also be used specifically to prevent physical gelation issues associated with materials that have high residual water content and prevent chemical gelation associated with materials that have high residual surface lithium sources. PDO, propylene glycol (PG), 1,2-butanediol (BDO), 1,3-butanediol (butylene glycol or BG), or 1,2-hexanediol (HDO) solvents (herein referred to the glycol solvents) are less likely to experience phase separation because the glycol solvents generally have higher miscibility with water than NMP, thus ensuring a more homogeneous solvent phase in the slurry. This may also lead to increased slurry stability times for challenging cathode slurries. For example, consider a lithium nickel cobalt manganese oxide (NCM) powder that was not properly vacuum dried and retained relatively high water content. Over time, the trace amount of water may diffuse from the CAM and into the liquid phase of the slurry. In NMP-based slurry, there may be a tendency to form microscale gels, especially when PVDF is added, due to low water-NMP miscibility and the insolubility of PVDF in water. This could lead to decreased cell-level performance due to microscale agglomerations in the electrode structure, or in the worst case, unstable slurries that do not properly coat and lead to unacceptable electrode quality. If instead, glycol and glycol-soluble binders are used, they will not gel with the small amount of water added by the NCM because the polymers (for example PVP) used with an alternative solvent binder package are also soluble in water. The co-solvation of the binder in glycols and water prevents phase separations of the binder and hence prevents this type of microscale physical gelation. The proposed glycol solvent and alternative binder package is more robust to water contamination, and this property may help avoid increased scrap rates which would save companies money in manufacturing.

Further, Dissolved PVDF in the presence of water in cathode slurries may also generate highly corrosive hydrofluoric acid (HF) due to localized heat generated during high shear mixing. The dehydrofluorination of PVDF in this manner can lead to sudden irreversible chemical crosslinking and unrecoverable slurry gelation on a macroscale. The result can be catastrophic and lead to entire batches of slurry that must be scrapped due to severely increased viscosity and solidification. Even if the dehydrofluorination of PVDF does not lead to unrecoverable slurry gelation, the presence of HF in the slurry may translate to the cathode and ultimately harm the cell level performance. These issues are avoided with the utilization of the alternative solvent/binder systems of this invention because the polymers used in the alternative solvent binder are not prone to chemical degradation and dehydrofluorination like PVDF in NMP.

Additionally, although water based PVDF emulsions or suspensions have recently attempted to come to market, it is not expected to be successful in replacing current state of the art solvent-based cathode solvent and binder packages due to the same corrosivity and instability issues described previously.

The invention therefore demonstrates significant advantages over a water-based or NMP-based process. One advantage includes less risk of large-scale failures due to the avoidance of pH related issues including corrosion, slurry instability, and decreased cell performance. Another advantage includes decreased issues with final drying and removal of water from completed cathodes due to lower overall introduced water. A further advantage includes removal of upstream residual lithium rinsing and drying steps from the CAM manufacturing process which decreases cost and increases lithium-ion battery manufacturer flexibility in CAM choices. Another advantage includes the reduction in physical and chemical gelation risks which reduces scrap rates.

In some embodiments of the cathode slurry composition, the one or more solvent-soluble first binders and/or the one or more solvent-soluble second binders are selected from the group consisting of polyvinylpyrrolidone (PVP), polyacrylic acid (PAA), polymethyl methacrylate (PMMA), polymethacrylic acid (PMA), polyvinyl alcohol (PVA), and a carboxyl methyl cellulose (CMC) derivative.

In some embodiments, the solvent-soluble first binders are the same as the solvent-soluble second binders. In some embodiments, the one or more solvent-soluble first binders are different than the one or more solvent-soluble second binders. In some embodiments, the one or more solvents used in the first mixture are the same as the one or more solvents used in the second mixture. In some embodiments, the one or more solvents used in the first mixture are different than the one or more solvents used in the second mixture.

In exemplary embodiments, the solvent is 1,3-propanediol (PDO) and the solvent-soluble first binder is polyvinylpyrrolidone (PVP) and/or polyacrylic acid (PAA). In some embodiments where PDO is the alternative solvent, the solvent-insoluble binder comprises styrene-butadiene rubber (SBR) and/or polyvinylidene fluoride (PVDF).

In some embodiments of the composition the solvent-soluble first binder comprises polyvinylpyrrolidone (PVP) or polyacrylic acid (PAA), and the solvent-insoluble discrete binder comprises styrene-butadiene rubber (SBR) or polyvinylidene fluoride (PVDF), wherein the solvent-insoluble discrete binder forms nanoparticles dispersed in the PDO. In some embodiments of the compositions, the solvent-soluble binder is a combination of PAA and PVP, and the solvent-insoluble discrete binder is a combination of SBR and PVDF.

The cathode active material (CAM) may be considered a host material for the lithium source in a lithium secondary battery (also colloquially known as a lithium-ion battery that is rechargeable). In some embodiments, the CAM may be a lithium intercalating or lithium alloying material. One primary example is lithium nickel cobalt manganese oxide (NCM). Generally, an NCM CAM will follow a formula which expresses a ratio between the lithium and the other elements.

The general formula for NCM is LiₓNi_{y}CO_{z}Mn_{(1-y-z)}O₂. Typically, a relatively high nickel content NCM will benefit most from the change of a conventional NMP/PVDF slurry basis to one of the alternative solvent/binder slurries of the invention, for example, PDO/PVP, or PDO/PAA, among others as disclosed herein. High nickel content NCM typically has a short-hand ratio of Ni:Co:Mn represented by a series of numbers. For example, for Li₁Ni₈Co₁Mn₁O₂, the ratio of Ni:Co:Mn is represented as “811”. The shorthand reference to such a material is therefore NCM 811. The subscript x indicates the ratio of lithium to the NCM host crystal structure and is often assumed to be equal to 1. When x=1, this refers to a stoichiometric ratio. When x>1, the stoichiometric ratio is exceeded, and this is referred to as a “lithium rich” or “lithium-rich” NCM material. Thus, one may encounter CAM that is referred to as a Lithium Rich NCM 811. For such materials, the present invention may indicate the greatest benefit.

As previously noted, lithium rich and high Ni content NCM CAM generally present the greatest challenges in slurry manufacturing with NMP and PVDF due to gelation issues. Lithium rich CAM, and high Ni content NCM, often have higher than average residual lithium sources that are not included into the bulk crystal structure of the material. This excess lithium on the surface of the CAM may be present as compounds including LiOH (lithium hydroxide) and LiCO₃ (lithium carbonate) which can be dissolved into water. An increase in such dissolved lithium sources may result in an increase of pH due to the alkalinity of the LiOH or LiCO₃. The increase in pH may lead to aluminum etching on the current collector of the cathode as well as increasing the rate of gelation of cathode slurries. The high pH of dissolved LiOH for example could lead to dehydrofluorination of the PVDF binder and resultant slurry gelation. Use of protic solvents such as PDO, PG, BDO, BG, HDO, 1-butanol, isobutanol, ethanol, or isopropanol, may help in reducing the pH of the slurry to decrease the rate of gelation.

The CAM may also include but is not limited to lithium nickel cobalt manganese oxide (NCM), lithium nickel cobalt aluminum oxide (NCA), lithium cobalt oxide (LCO), lithium manganese oxide (LMO), lithium iron phosphate (LFP), lithium iron manganese phosphate (LMFP), or any other variation of oxide, phosphate, whether layered, spinel, or olivine in crystal structure, including surface and bulk doped variations of all of the above.

A conductive additive is generally contained within a cathode slurry, for example, the conductive material is typically carbonaceous in nature. The conductive additive may take various forms from amorphous carbon, graphene, carbon nanotubes, porous carbon, to a common carbon black, and they may vary in shape in size. The selection of conductive additive is also not particularly limited to carbon containing compounds, and they may also include materials that are largely or entirely metallic. The particle size distribution (d50) of the conductive additive may range in size from several nanometers to several microns, and the aspect ratio or shape may range from spherical to rod-like or plate-like. The shape may be considered largely irregular as well as homogeneous.

### Methods for Preparing a Cathode Slurry Composition

As disclosed in more detail herein, the invention provides methods for preparing a cathode slurry composition.

In one aspect, the method for preparing a cathode slurry composition includes preparing one or more mixtures comprising one or more solvents; one or more solvent-soluble binders a conductive additive; a cathode active material (CAM); and a solvent-insoluble discrete binder, to form a homogenous cathode slurry composition.

The method includes providing one or more alternative solvents to NMP, for example, 1,3-propanediol (PDO). The one or more alternative solvents may be selected based on the similar physical and chemical properties as NMP, such that minimal changes to current slurry manufacturing processes need to be implemented. This does not indicate that embodiments presented within this disclosure are considered prior art. Other solvents similar to PDO and NMP may be selected as a replacement solvent for NMP as listed in Table 1 which include dimethyl sulfoxide (DMSO), dimethylformamide (DMF), dihydrolevoglucosenone (Cyrene), N,N′-dimethylpropyleneurea (DMPU), γ-valerolactone (GVL), 1,2-propanediol (propylene glycol or PG), 1,2-butanediol (BDO), 1,3-butanediol (butylene glycol or BG), 1,2-hexanediol (HDO), triethyl phosphate (TEP), ethyl acetate, propyl acetate, 1-butanol, isobutanol, ethanol, anisole, dimethyl carbonate (DMC), and propylene carbonate (PC).

The alternative solvent, for example 1,3-propanediol (PDO), may have a higher flash point (reduced flammability) than NMP which improves the safety considerations for manufacturing with heated processes. Other solvents that have a higher flash point than NMP include: cyrene, DMPU, GVL, PDO, PG, BDO, BG, HDO, TEP, and PC. As noted herein, the PDO and PG solvents may be significantly cheaper: on the order of 50% the cost of NMP. Also, some alternative solvents, such as PDO, may be desirable for their environmentally friendly attributes. PDO, for example, is not considered to be a volatile organic compound by the US EPA and can be manufactured via bio-fermentation.

The one or more alternative solvents may serve as the underlying main media to support a cathode slurry fabrication and production process. Several components may be mixed into the alternative solvent media including cathode active material, conductive additives, and polymer binders.

In some embodiments, other solvents, referred to as co-solvents, may also be added at various points in the slurry mixing process to serve various functions, which include but are not limited to viscosity modification, pH balancing and buffering, surfactant-based surface stabilization, surface tension modifiers for bubble reduction, boiling point modification, among other functions. Appropriate co-solvents of the invention include but are not limited to DMSO, DMF, cyrene, DMPU, GVL, PG, BDO, BG, HDO, TEP, ethyl acetate, propyl acetate, 1-butanol, isobutanol, ethanol, isopropanol, anisole, DMC, and PC. The DMC and anisole are non-polar however, so they may have limited to no miscibility in PDO or the other polar co-solvents, so care may need to be taken in exercising the amount added. These solvents may make better candidates as primary solvents for the slurry process rather than additives or co-solvents to PDO or other polar solvents. While PDO may be used in exemplary examples, any of the solvents listed may also be considered for the primary solvent role in place of PDO as they have properties that are appropriate for cathode slurry manufacturing.

As disclosed, the cathode slurry compositions using the alternative solvents/solvent binder packages of the invention may be prepared using one or more mixtures. In some embodiments, the cathode slurry compositions of the invention may be prepared using a single mixture. In some embodiments, the cathode slurry compositions may be prepared using a plurality of discrete mixtures. In some embodiments of the invention, the cathode slurry compositions may be prepared using, in non-limiting examples, two, three or four discrete mixtures.

As discussed in more detail herein, in exemplary embodiments, the methods for preparing a cathode slurry composition may include two processing routes in which two different mixtures may be prepared and combined to prepare the final slurry. This is advantageous as preparing two mixtures avoids gelation and provides good results at lab scale. In some embodiments, the first mixture and the second mixture are prepared as discrete mixtures and then combined. In other embodiments, the first mixture and the second mixture are prepared as a single mixture with all components. In some embodiments, the one or more solvents used in a first mixture may be the same as the one or more solvents used in a second mixture. In some embodiments, the one or more solvents used in the first mixture may be different than the one or more solvents used in the second mixture.

The cathode active material (CAM) may be considered a host material for the lithium source in a lithium secondary battery (also colloquially known as a lithium-ion battery that is rechargeable). In some embodiments, the CAM may be a lithium intercalating or lithium alloying material. One primary example is lithium nickel cobalt manganese oxide (NCM). Generally, an NCM CAM will follow a formula which expresses a ratio between the lithium and the other elements.

The general formula for NCM is LiₓNi_{y}Co_{z}Mn_{(1-y-z)}O₂. Typically, a relatively high nickel content NCM will benefit most from the change of a conventional NMP/PVDF slurry basis to one of the alternative solvent/binder slurries of the invention, for example, PDO/PVP, or PDO/PAA, among others as disclosed herein. High nickel content NCM typically has a short-hand ratio of Ni:Co:Mn represented by a series of numbers. For example, for Li₁Ni₈Co₁Mn₁O₂, the ratio of Ni:Co:Mn is represented as “811”. The shorthand reference to such a material is therefore NCM 811. The subscript x indicates the ratio of lithium to the NCM host crystal structure and is often assumed to be equal to 1. When x=1, this refers to a stoichiometric ratio. When x>1, the stoichiometric ratio is exceeded, and this is referred to as a “lithium rich” NCM material. Thus, one may encounter CAM that are referred to as a Lithium Rich NCM 811. For such materials, the present invention may indicate the greatest benefit.

Lithium rich and high Ni content NCM CAM generally present the greatest challenges in slurry manufacturing with NMP and PVDF due to gelation issues. Lithium rich CAM, and high Ni content NCM, often have higher than average residual lithium sources that are not included into the bulk crystal structure of the material. This excess lithium on the surface of the CAM may be present as compounds including LiOH (lithium hydroxide) and LiCO₃ (lithium carbonate) which can be dissolved into water. An increase in such dissolved lithium sources may result in an increase of pH due to the alkalinity of the LiOH or LiCO₃. The increase in pH may lead to aluminum etching on the current collector of the cathode as well as increasing the rate of gelation of cathode slurries. The high pH of dissolved LiOH for example could lead to dehydrofluorination of the PVDF binder and resultant slurry gelation. Use of protic solvents such as PDO, PG, BDO, BG, HDO, 1-butanol, isobutanol, ethanol, or isopropanol, may help in reducing the pH of the slurry to decrease the rate of gelation.

The CAM may also include but is not limited to lithium nickel cobalt manganese oxide (NCM), lithium nickel cobalt aluminum oxide (NCA), lithium cobalt oxide (LCO), lithium manganese oxide (LMO), lithium iron phosphate (LFP), lithium iron manganese phosphate (LMFP), or any other variation of oxide, phosphate, whether layered, spinel, or olivine in crystal structure, including surface and bulk doped variations of all of the above.

A conductive additive is generally contained within a cathode slurry, for example, the conductive material is typically carbonaceous in nature. The conductive additive may take various forms from amorphous carbon, graphene, carbon nanotubes, porous carbon, to a common carbon black, and they may vary in shape in size. The selection of conductive additive is also not particularly limited to carbon containing compounds, and they may also include materials that are largely or entirely metallic. The particle size distribution (d50) of the conductive additive may range in size from several nanometers to several microns, and the aspect ratio or shape may range from spherical to rod-like or plate-like. The shape may be considered largely irregular as well as homogeneous.

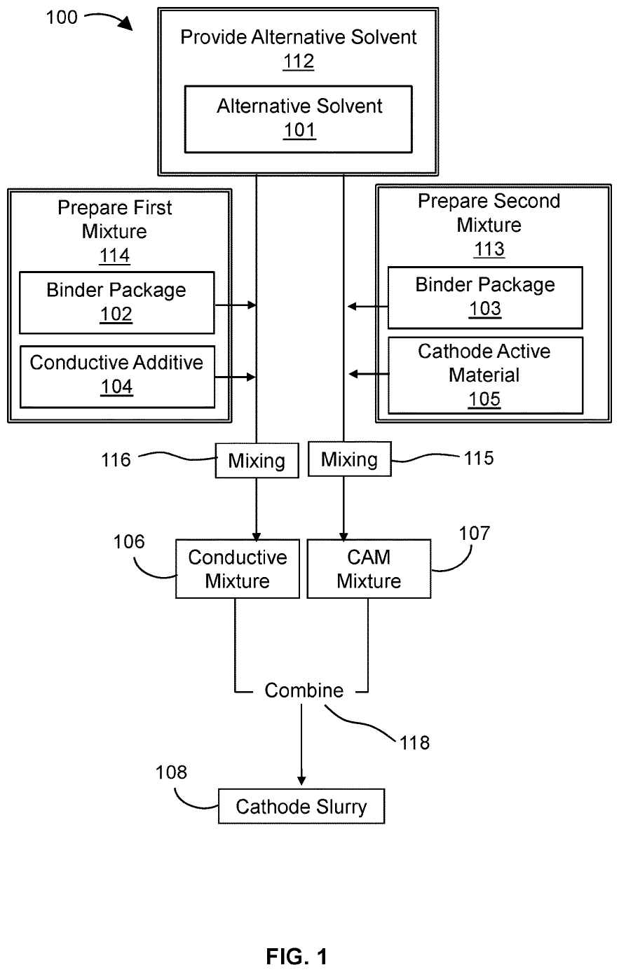

FIG. 1 illustrates a method for preparing 100 homogenous cathode slurry compositions according to one embodiment of the invention.

The method for preparing 100 a cathode slurry composition includes the step of providing 112 an alternative solvent 101. As disclosed herein, an alternative solvent is a solvent that may be used in the preparation of a lithium-ion battery electrode slurry that is not N-methyl-2-pyrrolidone (NMP). For example, the alternative solvent may be a solvent with properties studied and disclosed herein (See Table 1). The alternative solvent may be selected from the group consisting of: 1,3-propanediol (PDO), dimethyl sulfoxide (DMSO), dimethylformamide (DMF), dihydrolevoglucosenone (Cyrene), N,N′-dimethylpropyleneurea (DMPU), γ-valerolactone (GVL), 1,2-propanediol (propylene glycol or PG), 1,2-butanediol (BDO), 1,3-butanediol (butylene glycol or BG), 1,2-hexanediol (HDO), triethyl phosphate (TEP), ethyl acetate, propyl acetate, 1-butanol, isobutanol, ethanol, anisole, dimethyl carbonate (DMC), and propylene carbonate (PC).

In some embodiments of the method, preparing one or more mixtures includes the step of preparing a first mixture 114 comprising the one or more solvents, the one or more solvent-soluble binders, which may be referred to as a solvent-soluble first binder, and a conductive additive to form a first alternative solvent/binder package mixture, and mixing 116 the first mixture to produce a conductive additive mixture 106. Further, the method includes the step of preparing a second mixture 113 comprising the one or more solvents, the one or more solvent-soluble binders, which may be referred to as a solvent-soluble second binder, to form a second alternative solvent/binder package, a cathode active material (CAM), and a solvent-insoluble binder, and mixing 115 the second mixture to produce a mixture active material mixture 107. The method includes then combining 118 the first mixture and the second mixture to form a homogenous cathode slurry 108.

The method 100 represents key improvements to a typical slurry mixing process including separately generating the conductive and cathode active material dispersions in steps 106 and 107 respectively. By initially keeping these mixtures separate, several advantages are realized.

In some embodiments, the first binder package 102 may be specifically tailored to the dispersion and support needs of conductive additive 104 while the second binder package 103 may be tailored to the dispersion and support needs of cathode active material (CAM) 105. In some embodiments, the first binder package 102 and the second binder package 103 may be entirely different from one another. In other embodiments, the first binder package 102 and the second binder package may be generally identical. In some embodiments, the first binder package 102 may contain a singular component, low molecular weight, soluble binder such as PVP which allows for efficient mixing and stabilization of the conductive additive 104. In some embodiments, the second binder package 103 may contain an identical or non-identical soluble polymer binder to the first binder package 102 with similar or differing molecular weight, specifically tailored to support the much more dense and large particles of cathode active material within the alternative solvent. For example, for PDO as the alternative solvent, generally higher molecular weight polymers will better support a denser material.

In some embodiments, the first binder package 102 and/or the second binder package 103 may further contain an insoluble polymer binder emulsion such as styrene butadiene rubber (SBR) or polyvinylidene fluoride (PVDF). Such an insoluble binder in emulsion form may be referred to as a “discrete” binder.

In some embodiments, the addition of the discrete or soluble binders may occur after the initial dispersion of conductive additive or CAM with soluble binders, and at a relatively slower mixing speed, to prevent agglomeration of materials with the discrete binders. For each mixture 106 and mixture 107, the individual slurry viscosity, stability, homogeneity, and solids content may all be optimized and fine-tuned prior to final combination of mixtures 106 and 107 to produce cathode slurry 108.

In some embodiments, the first binder package 102 and/or the second binder package 103 may comprise a polymeric binder dissolvable in the alternative solvent 101. In non-limiting examples, for example when PDO is used as the alternative solvent 101, the polymeric binder may be polyvinylpyrrolidone (PVP) or polyacrylic acid (PAA), an insoluble binder in an emulsion form, such as styrene butadiene rubber (SBR) or polyvinylidene fluoride (PVDF) nanoparticles, or a combination of the two, such as a soluble PVP mixed with an insoluble emulsion of PVDF.

In some embodiments, the first binder package 102 and the second binder package 103 may be in the form of particulates or particles. The binder particles in one or more of the first binder package 102 and/or the second binder package 103 may have a range of sizes or may be close in size. The binder particles in the first binder package 102 and/or the second binder package 103 may have a D50 size range of 200 nm to 10 μm as a macro-emulsion (or may be about 3 μm), a D50 size range of 50 to 200 nm as a mini emulsion (or may be about 100 nm), or less than 50 nm as a micro emulsion (or may be about 25 nm).

In some embodiments, the composition of the first binder package may be the same as the composition of the second binder package. In some embodiments, the first binder package 102 and the second binder package 103 may include at least two components with differing compositions. For example, the first binder package 102 and/or the second binder package 103 may include one or more of PVP, PVA, PAA, polymethyl methacrylate (PMMA), polymethacrylic acid (PMA), polyethyl acrylate, polyvinyl acetate, polyvinylpyrrolidone-co-vinyl acetate (PVP-VA), polystyrene-co-styrenesulfonic acid (95:5) sodium salt, and cellulosic derivatives of lower molecular weight carboxymethyl cellulose (CMC) or other cellulosic polymers including but not limited to hydroxypropylmethyl cellulose (HPMC).

In some embodiments, the first binder package 102 may contain more than one soluble binder, where each binder may have different or identical chemical structure and may have different or identical molecular weights. The first binder package 102 may comprise polymers specific to stabilizing the conductive additive similar in function to a surfactant, whereas the other polymer, or polymers, would improve features such as viscosity modification or surface tension. In some embodiments, the conductive mixture 106 undergoes high shear and high energy mixing to properly disperse the conductive additive and yield a monodisperse or monomodal particle size distribution (PSD) to ensure conductive additives are not agglomerated in suspension.

In some embodiments, the second binder package 103 may contain at least one identical soluble polymer binder to the first binder package 102 with similar or differing molecular weight and further contain one more binders that may have identical chemical composition and further differing molecular weight, or one or more binders that have differing chemical composition.

As disclosed herein, in some embodiments, the first binder package 102 and/or the second binder package 103 may further contain a discrete, insoluble polymer binder emulsion such as styrene butadiene rubber (SBR) or polyvinylidene fluoride (PVDF). In some embodiments, the addition of the discrete or soluble binders may occur after the initial dispersion of conductive additive or cathode active material (CAM) with soluble binders, and at a relatively slower mixing speed, to prevent agglomeration of materials with the discrete binders. For each of mixture 106 and mixture 107, the individual slurry viscosity, stability, homogeneity, and solids content may all be optimized and fine-tuned prior to final combination of mixture 106 and mixture 107 to produce cathode slurry 108.

The conductive mixture 106 and cathode active material mixture 107 may be mixed in a benchtop double planetary, high shear, contactless/bladeless mixer such as a Thinky mixer, FLAKTEK, or Hauschild Speedmixer model. In some embodiments, mixing may be performed on larger scales including pilot scale, small production scale, and large production scale with planetary and rotary blade mixers (also referred to as double planetary and dispersing mixers respectively) such as models from Ross, Siehe, Ongoal, Jamieson, or others. In some examples, mixing may be conducted in vessels from 10 mL to 100 mL, 100 mL to 300 mL, 300 mL to 500 mL, and 500 mL to 750 mL in volume, which constitutes mixing at the benchtop scale. In other examples, mixing may be conducted in vessels from 750 mL to 2 L, 2 L to 10 L, 20 L to 25 L, and 50 L to 125 L in volume, which constitutes mixing at the pilot scale. In further examples, mixing may be conducted in vessels from 125 L to 500 L, 500 L to 1000 L and 1000 L to 5000 L in volume, which constitutes mixing at both the small and large production scales. In some examples, mixing may be conducted for 1 min, 5 min, 10 min, 30 min, 60 min, 90 min, or 120 min. In some embodiments, mixing may be conducted at 1000 RPM, 1500 RPM, 2000 RPM, 2500 RPM, or 3000 RPM for benchtop double planetary, high shear, contactless/bladeless mixers. In some embodiments, mixing may be conducted at 1000 RPM, 1500 RPM, 2000 RPM, 2500 RPM, 3000 RPM, 3500 RPM, 4000 RPM, or 4000 RPM to 7000 RPM for high shear, rotary disperser type mixers, at the pilot and production scales. In some embodiments, mixing may be conducted at 10 RPM to 50 RPM, 50 RPM to 100 RPM, 100 RPM to 200 RPM, or 200 RPM to 500 RPM for double planetary, high torque, dual blade mixers at the pilot and production scales. In further embodiments, multiple types of mixers may be used simultaneously at the pilot and production scales. In some examples, the combination of high shear, high speed, rotary disperser mixing blades may be contained in the same mixing machine as the double planetary, high torque, dual blade mixer, and operated simultaneously. In a mixer with multiple mixing blades of different types, a combination of mixing RPM may be appropriately used. In some examples, such a combination mixer may conduct mixing with the double planetary, high torque, dual blades (referred to herein as double planetary blades) operating at 10 RPM to 50 RPM, 50 RPM to 100 RPM, 100 RPM to 200 RPM, or 200 RPM to 500 RPM while the high shear, high speed, rotary disperser mixing blades (referred to herein as disperser blades) may simultaneously operate at 1000 RPM, 1500 RPM, 2000 RPM, 2500 RPM, 3000 RPM, 3500 RPM, 4000 RPM, or 4000 RPM to 7000 RPM. In other embodiments, a combination mixer may operate with one or both of the double planetary or disperser blades operating simultaneously or one at a time. A type of container and process of mixing used is not limited and is variable according to the operator and known to those skilled in the art. Mixing parameters may be varied to tailor to the specific needs of the materials chosen in conductive mixture 106 and CAM mixture 107.

In some embodiments, the first binder package 102 and the second binder package 103 may contain components of varying molecular weight such that the first binder package and the second binder package vary in molecular weight. For example, the first binder package 102 may include two binders with different molecular weights: a low molecular weight binder (for dispersion of the conductive additive 104, for example) and a high molecular weight binder (as a thickener for improving slurry stability and/or an adhesion promoter for improving coating quality), where the low molecular weight binder may have a lower molecular weight than the high molecular weight binder. In some examples, the molecular weight of the low molecular weight binder may be between 5,000 and 120,000 Da or between 25,000 and 850,000 Da. In some examples, the molecular weight of the high molecular weight binder may be between 200,000 and 850,000 Da or between 450,000 and 1,000,000 Da. In some embodiments, two binders may be combined that have identical chemical composition but only vary in molecular weight in which one molecular weight is higher than the other. For example, low molecular weight and high molecular weight PAA or PVP may be combined. In other embodiments, the low molecular weight binder and the high molecular weight binder may have different compositions.

In some embodiments, the cathode slurry 108 may have a dynamic viscosity of at least 10,000 cP at 85 s-1. In some examples, the viscosity may be between 10,000 cP and 200,000 cP. In other embodiments, the viscosity may depend upon the solids content of the cathode slurry 108 and/or a composition of the cathode active material 102. As a result, greater control may be afforded over various coating parameters and rheological properties of the cathode slurry 108.

In some embodiments, the cathode slurry 108 may have a solids content of 10-90% solids, 20-80% solids, 30-70% solids, or 40-60% solids. In some embodiments, the cathode slurry 108 may have solids content of 10-50% solids, 10-40% solids, 10-30% solids, 10-20% solids, or 5-10% solids. In some embodiments, the cathode slurry 108 may have solids content of 60-95% solids, 70-95% solids, 80-95% solids, or 90-95% solids.

As disclosed herein, exemplary embodiments for methods for preparing a cathode slurry composition include two processing routes in which two different mixtures are made and combined to prepare the final slurry. This is advantageous as preparing two mixtures avoids gelation and provides good results at lab scale. However, it is noted that the alternative solvents identified herein and used for preparing a lithium-ion battery electrode may be used with a single mixture of one or more binder packages, conductive additives, and cathode active material.

### Methods for Manufacturing a Lithium-Ion Battery Electrode

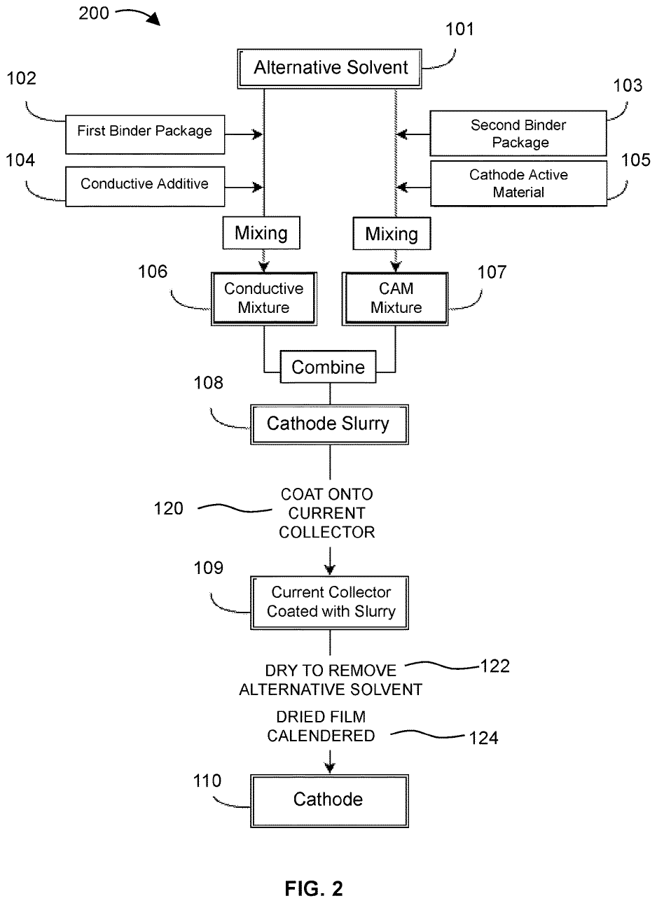

FIG. 2 illustrates a block diagram of a method for manufacturing a lithium-ion battery electrode 200, according to one embodiment of the invention.

The method illustrated in FIG. 2 represents an overall process for mixing the previously detailed, major components of the cathode slurry in such a manner to benefit the properties of the slurry for subsequent steps including coating, drying, and calendaring (pressed to a target thickness and porosity upon drying). By using alternative solvents to optimize the formulations of the first binder package 102 and the second binder package 103, and selecting appropriate conductive additives in 104 and cathode active material (CAM) 105, one skilled in the art may apply the combinations and slurry mixing processes to obtain a cathode slurry in 108 that coats well onto a foil or non-foil substrate to fabricate a lithium-ion battery electrode. Key properties include solids content, slurry viscosity and rheology, and homogeneity of the slurry (well distributed conductive additive within a polymer/solvent matrix to properly support a dispersed CAM, rendering a stable slurry microstructure).

Aspects of the invention provide a method for manufacturing a lithium-ion battery electrode. The method includes the steps of providing 112 an alternative solvent 101. As disclosed herein, an alternative solvent is a solvent that may be used in the preparation of a lithium-ion battery electrode slurry that is not N-methyl-2-pyrrolidone (NMP). For example, the alternative solvent may be a solvent with properties studied and disclosed herein (See Table 1). The alternative solvent may be selected from the group consisting of: 1,3-propanediol (PDO), dimethyl sulfoxide (DMSO), dimethylformamide (DMF), dihydrolevoglucosenone (Cyrene), N,N′-dimethylpropyleneurea (DMPU), γ-valerolactone (GVL), 1,2-propanediol (propylene glycol or PG), 1,2-butanediol (BDO), 1,3-butanediol (butylene glycol or BG), 1,2-hexanediol (HDO), triethyl phosphate (TEP), ethyl acetate, propyl acetate, 1-butanol, isobutanol, ethanol, anisole, dimethyl carbonate (DMC), and propylene carbonate (PC).

The method includes preparing one or more mixtures comprising one or more alternative solvents; one or more solvent-soluble binders; a conductive additive; a cathode active material (CAM); and a solvent-insoluble discrete binder, to form a homogenous cathode slurry composition. Further, the method includes coating the cathode slurry onto a current collector, and drying and calendaring to a target thickness and porosity upon drying to thereby fabricate a lithium-ion battery electrode.

In some embodiments of the method 200, preparing the one or more mixtures includes the step of preparing a first mixture 114 comprising the one or more solvents and the one or more solvent-soluble binders to form a first binder package, and a conductive additive, and mixing 116 the first mixture to produce a conductive additive mixture 106. Further, the method includes the step of preparing a second mixture 113 comprising the one or more solvents and the solvent-soluble binders to form a second binder package, a cathode active material (CAM), and a solvent-insoluble binder, and mixing 115 the second mixture to produce a mixture active material mixture 107. The method includes then combining 118 the first mixture and the second mixture to form a homogenous cathode slurry 108.

Further, the method for manufacturing a lithium-ion battery electrode includes the steps of coating 120 the cathode slurry 108 onto a cathode current collector. In some embodiments of the method 200, the cathode slurry 108 may be spread, cast, or deposited, onto a conductive metallic substrate, also known as a “current collector”, to form a current collector coated with slurry 109. Thus, the method includes the step of coating 120 the cathode slurry onto the current collector.

The current collector may be composed of metal foil, such as aluminum foil, especially when used for a cathode. In such an example, the aluminum foil may have a thickness of 8-30 μm. In some embodiments, the current collector may have the thickness of 12 μm to reduce dead weight within an electrode stack, thus increasing the overall energy density at the device level. The cathode slurry 108 may be applied to the substrate using a slot-die coater, a doctor blade via drawdown, bar coating, or among other methods. The cathode slurry 108 may be cast with a drawdown applicator and may be cast on an automatic drawdown table. Other slurry-based coating processes may be utilized, including but not limited to, slot-die coating, roll-to-roll coating, spray (aerosol) coating, reverse comma coating, among others, and as is known to persons skilled in the art.

After the cathode slurry 108 is applied to the current collector to form the slurry-coated conductive substrate 109, the alternative solvent 101 may be removed 122 via evaporation. Heating may be applied at a temperature of less than 220° C. Maximum heating temperature is determined by the melting point of the polymers used in binder packages 102 and 103. It is therefore desired to remove the alternative solvent with a maximum heating temperature less than 220° C. The resultant dried film may further be calendered 124 to a target press density. The cathode 110 may then be formed.

The method 200 for manufacturing a lithium-ion battery electrode may be summarized by mixing the conductive additive 104 with a first binder package 102 to form conductive mixture 106, mixing the CAM 105 with a second binder package 103 to form CAM mixture 107, combining the conductive mixture 106 and CAM mixture 107 to generate cathode slurry 108, coating 120 the cathode slurry 108 onto the conductive substrate to form the current collector coated with slurry 109, drying 122 the current collector coated with slurry 109, and calendaring 124 the dried film to finally result in cathode 110. It will be appreciated that, within the cathode the method 200 for manufacturing a lithium-ion battery electrode, additional additives or processes may be included, removed, or altered by those skilled in the art.

In some embodiments, one or more of the first binder package 102 and the second binder package 103 may be heat-treated after coating a full electrode to form a cross-linked polymer from at least two components. The heat treatment may also be applied to such an example in the first binder package 102 and/or the second binder package 103 in the liquid state to instigate crosslinking prior to slurry mixing.

The cathode active material (CAM) may be considered a host material for the lithium source in a lithium secondary battery (also colloquially known as a lithium-ion battery that is rechargeable). In some embodiments, the CAM may be a lithium intercalating or lithium alloying material. One primary example is lithium nickel cobalt manganese oxide (NCM). Generally, an NCM CAM will follow a formula which expresses a ratio between the lithium and the other elements.

As noted herein, the general formula for NCM is LiₓNi_{y}Co_{z}Mn_{(1-y-z)}O₂. Typically, a relatively high nickel content NCM will benefit most from the change of a conventional NMP/PVDF slurry basis to one of the alternative solvent/binder slurries of the invention, for example, PDO/PVP, PDO/PAA, among others as disclosed herein. High nickel content NCM typically has a short-hand ratio of Ni:Co:Mn represented by a series of numbers. For example, for Li₁Ni₈Co₁Mn₁O₂, the ratio of Ni:Co:Mn is represented as “811”. The shorthand reference to such a material is therefore NCM 811. The subscript x indicates the ratio of lithium to the NCM host crystal structure and is often assumed to be equal to 1. When x=1, this refers to a stoichiometric ratio. When x>1, the stoichiometric ratio is exceeded, and this is referred to as a “lithium rich” NCM material. Thus, one may encounter CAM that are referred to as a Lithium Rich NCM 811. For such materials, the present invention may indicate the greatest benefit.

Lithium rich and high Ni content NCM CAM generally present the greatest challenges in slurry manufacturing with NMP and PVDF due to gelation issues. Lithium rich CAM, and high Ni content NCM, often have higher than average residual lithium sources that are not included into the bulk crystal structure of the material. This excess lithium on the surface of the CAM may be present as compounds including LiOH (lithium hydroxide) and LiCO₃ (lithium carbonate) which can be dissolved into water. An increase in such dissolved lithium sources may result in an increase of pH due to the alkalinity of the LiOH or LiCO₃. The increase in pH may lead to aluminum etching on the current collector of the cathode as well as increasing the rate of gelation of cathode slurries. The high pH of dissolved LiOH for example could lead to dehydrofluorination of the PVDF binder and resultant slurry gelation. Use of protic solvents such as PDO, PG, BDO, BG, HDO, 1-butanol, isobutanol, ethanol, or isopropanol, may help in reducing the pH of the slurry to decrease the rate of gelation.

The CAM may also include but is not limited to lithium nickel cobalt manganese oxide (NCM), lithium nickel cobalt aluminum oxide (NCA), lithium cobalt oxide (LCO), lithium manganese oxide (LMO), lithium iron phosphate (LFP), lithium iron manganese phosphate (LMFP), or any other variation of oxide, phosphate, whether layered, spinel, or olivine in crystal structure, including surface and bulk doped variations of all of the above.

A conductive additive is generally contained within a cathode slurry, for example, the conductive material is typically carbonaceous in nature. The conductive additive may take various forms from amorphous carbon, graphene, carbon nanotubes, porous carbon, to a common carbon black, and they may vary in shape in size. The selection of conductive additive is also not particularly limited to carbon containing compounds, and they may also include materials that are largely or entirely metallic. The particle size distribution (d50) of the conductive additive may range in size from several nanometers to several microns, and the aspect ratio or shape may range from spherical to rod-like or plate-like. The shape may be considered largely irregular as well as homogeneous.

In some embodiments, the first binder package may be specifically tailored to the dispersion and support needs of conductive additive while the second binder package may be tailored to the dispersion and support needs of cathode active material (CAM). In some embodiments, the first binder package and the second binder package may be entirely different from one another. In other embodiments, the first binder package and the second binder package may be generally identical. In some embodiments, the first binder package may contain a singular component, low molecular weight, soluble binder such as PVP which allows for efficient mixing and stabilization of the conductive additive. In some embodiments, the second binder package may contain an identical or non-identical soluble polymer binder to the first binder package with similar or differing molecular weight, specifically tailored to support the much more dense and large particles of catheter active material within the alternative solvent. For example, for PDO as the alternative solvent, generally higher molecular weight polymers will better support a denser material.

In some embodiments, the first binder package and/or the second binder package may further contain an insoluble polymer binder emulsion such as styrene butadiene rubber (SBR) or polyvinylidene fluoride (PVDF). As disclosed herein, such an insoluble binder in emulsion form may be referred to as a “discrete” binder.

In some embodiments, the addition of the discrete or soluble binders may occur after the initial dispersion of conductive additive or CAM with soluble binders, and at a relatively slower mixing speed, to prevent agglomeration of materials with the discrete binders. For each mixture 106 and mixture 107, the individual slurry viscosity, stability, homogeneity, and solids content may all be optimized and fine-tuned prior to final combination of mixtures to produce cathode slurry.

In some embodiments, the first binder package and/or the second binder package may comprise a polymeric binder dissolvable in the alternative solvent. In non-limiting examples, for example when PDO is used as the alternative solvent, the polymeric binder may be polyvinylpyrrolidone (PVP) or polyacrylic acid (PAA), an insoluble binder in an emulsion form, such as styrene butadiene rubber (SBR) or polyvinylidene fluoride (PVDF) nanoparticles, or a combination of the two, such as a soluble PVP mixed with an insoluble emulsion of PVDF.

In some embodiments, the first binder package and the second binder package may be in the form of particulates or particles. The binder particles in one or more of the first binder package and/or the second binder package may have a range of sizes or may be close in size. The binder particles in the first binder package and/or the second binder package may have a D50 size range of 200 nm to 10 μm as a macro-emulsion (or may be about 3 μm), a D50 size range of 50 to 200 nm as a mini emulsion (or may be about 100 nm), or less than 50 nm as a micro emulsion (or may be about 25 nm).

As disclosed herein, in some embodiments of the method, the one or more solvent-soluble binders are selected from the group consisting of polyvinylpyrrolidone (PVP), polyacrylic acid (PAA), polymethyl methacrylate (PMMA), polymethacrylic acid (PMA), polyvinyl alcohol (PVA), and a carboxyl methyl cellulose (CMC) derivative.

In some embodiments, the composition of the first binder package is the same as the composition of the second binder package. In some embodiments, the first binder package and the second binder package may include at least two components with differing compositions. For example, the first binder package and/or the second binder package may include one or more of PVP, PVA, PAA, polymethyl methacrylate (PMMA), polymethacrylic acid (PMA), polyethyl acrylate, polyvinyl acetate, polyvinylpyrrolidone-co-vinyl acetate (PVP-VA), polystyrene-co-styrenesulfonic acid (95:5) sodium salt, and cellulosic derivatives of lower molecular weight carboxymethyl cellulose (CMC) or other cellulosic polymers including but not limited to hydroxypropylmethyl cellulose (HPMC).

In some embodiments of the method, the one or more solvent-soluble binders in the first mixture are the same as the one or more solvent-soluble binders in the second mixture. In some embodiments of the method, the one or more solvent-soluble binders in the first mixture are different than the one or more solvent-soluble binders in the second mixture. In some embodiments, the one or more solvents used in the first mixture are the same as the one or more solvents used in the second mixture. In some embodiments, the one or more solvents used in the first mixture are different than the one or more solvents used in the second mixture.

In some embodiments, the first binder package may contain more than one soluble binder, where each binder may have different or identical chemical structure and may have different or identical molecular weights. The first binder package may comprise polymers specific to stabilizing the conductive additive similar in function to a surfactant, whereas the other polymer, or polymers, would improve features such as viscosity modification or surface tension. In some embodiments, the conductive mixture undergoes high shear and high energy mixing to properly disperse the conductive additive and yield a monodisperse or monomodal particle size distribution (PSD) to ensure conductive additives are not agglomerated in suspension.

In some embodiments, the second binder package may contain at least one identical soluble polymer binder to the first binder package with similar or differing molecular weight and further contain one more binders that may have identical chemical composition and further differing molecular weight, or one or more binders that have differing chemical composition.

As disclosed herein, in some embodiments, the first binder package and/or the second binder package may further contain a discrete, insoluble polymer binder emulsion such as styrene butadiene rubber (SBR) or polyvinylidene fluoride (PVDF). In some embodiments, the addition of the discrete or soluble binders may occur after the initial dispersion of conductive additive or cathode active material (CAM) with soluble binders, and at a relatively slower mixing speed, to prevent agglomeration of materials with the discrete binders. For each of mixture 106 and mixture 107, the individual slurry viscosity, stability, homogeneity, and solids content may all be optimized and fine-tuned prior to final combination of mixture 106 and mixture 107 to produce cathode slurry.

In some embodiments of the method, the solvent comprises 1,3-propanediol (PDO). In some embodiments, the one or more solvent-soluble binders comprises polyvinylpyrrolidone (PVP) or polyacrylic acid (PAA), and the solvent-insoluble discrete binder comprises styrene-butadiene rubber (SBR) or polyvinylidene fluoride (PVDF), wherein the solvent-insoluble discrete binder forms nanoparticles dispersed in the PDO. In some embodiments, the solvent-soluble binder is a combination of PAA and PVP, and the solvent-insoluble discrete binder is a combination of SBR and PVDF. In some embodiments both the solvent-soluble first binder and the solvent-soluble second binder are a combination of PAA and PVP.

In some embodiments, the CAM is a lithium intercalating or lithium alloying material. Lithium nickel cobalt manganese oxide (NCM) lithium nickel cobalt aluminum oxide (NCA), lithium cobalt oxide (LCO), lithium manganese oxide (LMO), lithium iron phosphate (LFP), and lithium iron manganese phosphate (LMFP).

The conductive mixture 106 and cathode active material mixture 107 may be mixed in a benchtop double planetary, high shear, contactless/bladeless mixer such as a Thinky mixer, FLAKTEK, or Hauschild Speedmixer model. In some embodiments, mixing may be performed on larger scales including pilot scale, small production scale, and large production scale with planetary and rotary blade mixers (also referred to as double planetary and dispersing mixers respectively) such as models from Ross, Siehe, Ongoal, Jamieson, or others. In some examples, mixing may be conducted in vessels from 10 mL to 100 mL, 100 mL to 300 mL, 300 mL to 500 mL, and 500 mL to 750 mL in volume, which constitutes mixing at the benchtop scale. In other examples, mixing may be conducted in vessels from 750 mL to 2 L, 2 L to 10 L, 20 L to 25 L, and 50 L to 125 L in volume, which constitutes mixing at the pilot scale. In further examples, mixing may be conducted in vessels from 125 L to 500 L, 500 L to 1000 L and 1000 L to 5000 L in volume, which constitutes mixing at both the small and large production scales. In some examples, mixing may be conducted for 1 min, 5 min, 10 min, 30 min, 60 min, 90 min, or 120 min. In some embodiments, mixing may be conducted at 1000 RPM, 1500 RPM, 2000 RPM, 2500 RPM, or 3000 RPM for benchtop double planetary, high shear, contactless/bladeless mixers. In some embodiments, mixing may be conducted at 1000 RPM, 1500 RPM, 2000 RPM, 2500 RPM, 3000 RPM, 3500 RPM, 4000 RPM, or 4000 RPM to 7000 RPM for high shear, rotary disperser type mixers, at the pilot and production scales. In some embodiments, mixing may be conducted at 10 RPM to 50 RPM, 50 RPM to 100 RPM, 100 RPM to 200 RPM, or 200 RPM to 500 RPM for double planetary, high torque, dual blade mixers at the pilot and production scales. In further embodiments, multiple types of mixers may be used simultaneously at the pilot and production scales. In some examples, the combination of high shear, high speed, rotary disperser mixing blades may be contained in the same mixing machine as the double planetary, high torque, dual blade mixer, and operated simultaneously. In a mixer with multiple mixing blades of different types, a combination of mixing RPM may be appropriately used. In some examples, such a combination mixer may conduct mixing with the double planetary, high torque, dual blades (referred to herein as double planetary blades) operating at 10 RPM to 50 RPM, 50 RPM to 100 RPM, 100 RPM to 200 RPM, or 200 RPM to 500 RPM while the high shear, high speed, rotary disperser mixing blades (referred to herein as disperser blades) may simultaneously operate at 1000 RPM, 1500 RPM, 2000 RPM, 2500 RPM, 3000 RPM, 3500 RPM, 4000 RPM, or 4000 RPM to 7000 RPM. In other embodiments, a combination mixer may operate with one or both of the double planetary or disperser blades operating simultaneously or one at a time. A type of container and process of mixing used is not limited and is variable according to the operator and known to those skilled in the art. Mixing parameters may be varied to tailor to the specific needs of the materials chosen in conductive mixture 106 and CAM mixture 107.

As disclosed herein, in some embodiments of the invention, the conductive additive is one or more of amorphous carbon, graphene, carbon nanotubes, porous carbon, and carbon black.

In some embodiments, the first binder package and the second binder package may contain components of varying molecular weight such that the first binder package and the second binder package vary in molecular weight. For example, the first binder package may include two binders with different molecular weights: a low molecular weight binder (for dispersion of the conductive additive, for example) and a high molecular weight binder (as a thickener for improving slurry stability and/or an adhesion promoter for improving coating quality), where the low molecular weight binder may have a lower molecular weight than the high molecular weight binder. In some examples, the molecular weight of the low molecular weight binder may be between 5,000 and 120,000 Da or between 25,000 and 850,000 Da. In some examples, the molecular weight of the high molecular weight binder may be between 200,000 and 850,000 Da or between 450,000 and 1,000,000 Da. In some embodiments, two binders may be combined that have identical chemical composition but only vary in molecular weight in which one molecular weight is higher than the other. For example, low molecular weight and high molecular weight PAA or PVP may be combined. In other embodiments, the low molecular weight binder and the high molecular weight binder may have different compositions.

In some embodiments, the cathode slurry may have a dynamic viscosity of at least 10,000 cP at 85 s-1. In some examples, the viscosity may be between 10,000 cP and 200,000 cP. In other embodiments, the viscosity may depend upon the solids content of the cathode slurry and/or a composition of the cathode active material. As a result, greater control may be afforded over various coating parameters and rheological properties of the cathode slurry.

In some embodiments, the cathode slurry may have a solids content of 10-90% solids, 20-80% solids, 30-70% solids, or 40-60% solids. In some embodiments, the cathode slurry 108 may have solids content of 10-50% solids, 10-40% solids, 10-30% solids, 10-20% solids, or 5-10% solids. In some embodiments, the cathode slurry 108 may have solids content of 60-95% solids, 70-95% solids, 80-95% solids, or 90-95% solids.

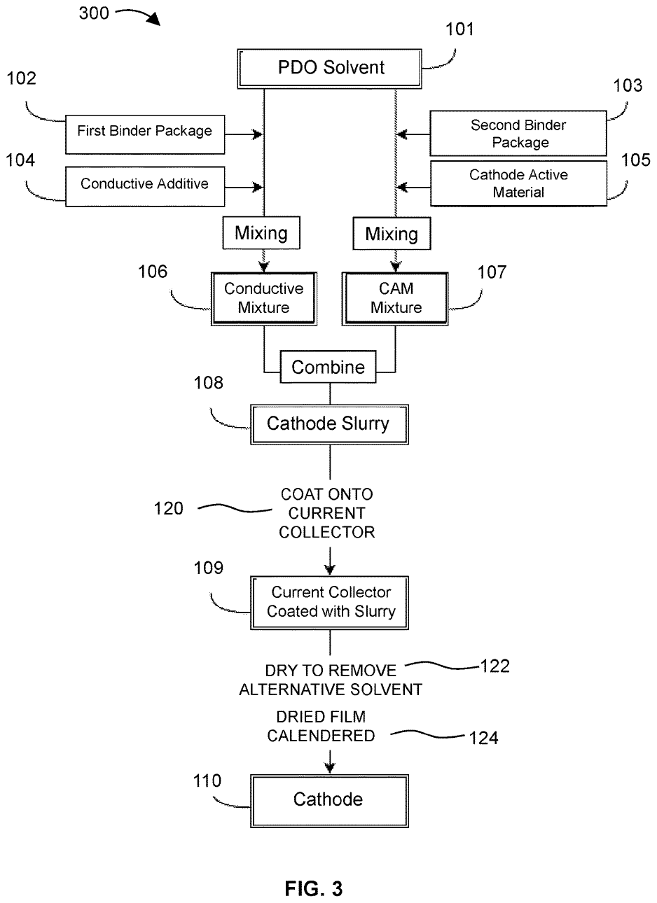

FIG. 3 illustrates a block diagram of a process 300 of binder dissolution in which PDO is used as the alternative solvent, slurry mixing, coating, and drying which results in a completed electrode.

As disclosed herein, exemplary embodiments for methods for preparing a cathode slurry composition include two processing routes in which two different mixtures are made and combined to prepare the final slurry. This is advantageous as preparing two mixtures avoids gelation and provides good results at lab scale. However, it is noted that the alternative solvents identified herein and used for preparing a lithium-ion battery electrode may be used with a single mixture of one or more binder packages, conductive additives, and cathode active material.

### Lithium-Ion Cell Using Alternative Solvent/Binder Package Compositions

Aspects of the invention provide a lithium-ion cell. In some embodiments, the lithium-ion cell comprises a cathode, the cathode being formed from an alternative solvent slurry 108 coated on a conductive substrate, wherein the alternative solvent is not N-methyl-2-pyrrolidone (NMP). The slurry comprises one or mixtures comprising: one or more alternative solvents; a conductive additive; a lithium-containing cathode active material (CAM); one or more solvent-soluble binders; and nanoparticles formed from a solvent-insoluble, discrete binder, wherein the one or more solvent soluble binders and the nanoparticles are dispersed within the one or more solvents.

The alternative solvent may be, for example, 1,3-propanediol (PDO), dimethyl sulfoxide (DMSO), dimethylformamide (DMF), dihydrolevoglucosenone (Cyrene), N,N′-dimethylpropyleneurea (DMPU), γ-valerolactone (GVL), 1,3-propanediol (PDO), 1,2-propanediol (propylene glycol or PG), 1,2-butanediol (BDO), 1,3-butanediol (butylene glycol or BG), 1,2-hexanediol (HDO), triethyl phosphate (TEP), ethyl acetate, propyl acetate 1-butanol, isobutanol, ethanol, isopropanol, and propylene carbonate (PC).

In some embodiments, the alternative solvent is PDO, thus, the slurry is a PDO slurry comprising a PDO solvent, a lithiated cathode active material, a conductive additive, and a polyacrylic acid (PAA) binder dispersed in the PDO solvent, an anode, a separator placed in between the cathode and the anode, and an electrolyte that touches the separator, anode, and cathode. In some embodiments, the slurry is a PDO slurry comprising a PDO solvent, a lithiated cathode active material, a conductive additive, and a polyvinylpyrrolidone (PVP) binder dispersed in the PDO solvent, an anode, a separator placed in between the cathode and the anode, and an electrolyte that touches the separator, anode, and cathode.

The anode active material may include one or more of lithium metal, graphite, graphene, lithium titanium oxide (LTO), silicon, a silicon oxide, or a carbon-silicon composite. The separator may include but is not limited to polyethylene (PE) and PE derivatives, non-woven polymeric polyimide (PI) and Teflon (PTFE) derivatives, glass fiber (GF), and ceramic coated variations of PE, PI, PTFE, and GF. The electrolyte may consist of an industry-typical ethylene carbonate (EC) dimethyl carbonate (DMC) solvent mixture with a ratio of 1:1 and a 1M concentration of LiPF₆ salt, or any combination of alkyl carbonate, cyclic carbonate, sulfonated organic molecule such as sulfolane, or ionic liquid, and any concentration of any lithium salts that those skilled in the art may devise.

Further, in some embodiments, the separator and the electrolyte may be entirely replaced by a singular layer of solid-state electrolyte (SSE) that serves both roles as separator and electrolyte in the battery.

The one or more alternative solvents may serve as the underlying main media to support a cathode slurry fabrication and production process. Several components may be mixed into the alternative solvent media including cathode active material, conductive additives, and polymer binders. In some embodiments, other solvents, referred to as co-solvents, may also be added at various points in the slurry mixing process to serve various functions, which include but are not limited to viscosity modification, pH balancing and buffering, surfactant-based surface stabilization, surface tension modifiers for bubble reduction, boiling point modification, among other functions. Appropriate co-solvents of the invention include but are not limited to DMSO, DMF, cyrene, DMPU, GVL, PG, BDO, BG, HDO, TEP, ethyl acetate, propyl acetate, 1-butanol, isobutanol, ethanol, isopropanol, anisole, DMC, and PC. The DMC and anisole are non-polar however, so they may have limited to no miscibility in PDO or the other polar co-solvents, so care may need to be taken in exercising the amount added. These solvents may make better candidates as primary solvents for the slurry process rather than additives or co-solvents to PDO or other polar solvents. While PDO may be used in exemplary examples, any of the solvents listed may also be considered for the primary solvent role in place of PDO as they have properties that are appropriate for cathode slurry manufacturing.

The cathode active material may be considered a host material for the lithium source in a lithium secondary battery (also colloquially known as a lithium-ion battery that is rechargeable). In some embodiments, the CAM may be a lithium intercalating or lithium alloying material. One primary example is lithium nickel cobalt manganese oxide (NCM). Generally, an NCM CAM will follow a formula which expresses a ratio between the lithium and the other elements.

The general formula for NCM is LiₓNi_{y}Co_{z}Mn_{(1-y-z)}O₂. Typically, a relatively high nickel content NCM will benefit most from the change of a conventional NMP/PVDF slurry basis to one of the alternative solvent/binder slurries of the invention, for example, PDO/PVP, PDO/PAA, among others as disclosed herein. High nickel content NCM typically has a short-hand ratio of Ni:Co:Mn represented by a series of numbers. For example, for Li₁Ni₈Co₁Mn₁O₂, the ratio of Ni:Co:Mn is represented as “811”. The shorthand reference to such a material is therefore NCM 811. The subscript x indicates the ratio of lithium to the NCM host crystal structure and is often assumed to be equal to 1. When x=1, this refers to a stoichiometric ratio. When x>1, the stoichiometric ratio is exceeded, and this is referred to as a “lithium rich” NCM material. Thus, one may encounter CAM that are referred to as a Lithium Rich NCM 811. For such materials, the present invention may indicate the greatest benefit.

As noted herein, lithium-rich and high Ni content NCM CAM generally present the greatest challenges in slurry manufacturing with NMP and PVDF due to gelation issues. Lithium rich CAM, and high Ni content NCM, often have higher than average residual lithium sources that are not included into the bulk crystal structure of the material. This excess lithium on the surface of the CAM may be present as compounds including LiOH (lithium hydroxide) and LiCO₃ (lithium carbonate) which can be dissolved into water. An increase in such dissolved lithium sources may result in an increase of pH due to the alkalinity of the LiOH or LiCO₃. The increase in pH may lead to aluminum etching on the current collector of the cathode as well as increasing the rate of gelation of cathode slurries. The high pH of dissolved LiOH for example could lead to dehydrofluorination of the PVDF binder and resultant slurry gelation. Use of protic solvents such as PDO, PG, BDO, BG, HDO, 1-butanol, isobutanol, ethanol, or isopropanol, may help in reducing the pH of the slurry to decrease the rate of gelation.

The CAM may also include but is not limited to lithium nickel cobalt manganese oxide (NCM), lithium nickel cobalt aluminum oxide (NCA), lithium cobalt oxide (LCO), lithium manganese oxide (LMO), lithium iron phosphate (LFP), lithium iron manganese phosphate (LMFP), or any other variation of oxide, phosphate, whether layered, spinel, or olivine in crystal structure, including surface and bulk doped variations of all of the above.

A conductive additive is generally contained within a cathode slurry, for example, the conductive material is typically carbonaceous in nature. The conductive additive may take various forms from amorphous carbon, graphene, carbon nanotubes, porous carbon, to a common carbon black, and they may vary in shape in size. The selection of conductive additive is also not particularly limited to carbon containing compounds, and they may also include materials that are largely or entirely metallic. The particle size distribution (d50) of the conductive additive may range in size from several nanometers to several microns, and the aspect ratio or shape may range from spherical to rod-like or plate-like. The shape may be considered largely irregular as well as homogeneous.

In some embodiments of the lithium-ion cell, the one or more mixtures comprises a first mixture comprising the one or more alternative solvents, the one or more solvent-soluble binders, and the conductive additive. The one or more mixtures further comprises a second mixture comprising the one or more alternative solvents, the one or more solvent-soluble binders, the lithium-containing cathode active material (CAM), and nanoparticles formed from the solvent-insoluble, discrete binder. Thus, the cathode slurry composition may be prepared by preparing a first mixture comprising the one or more alternative solvents, the one or more solvent-soluble binders, and a conductive additive to form an alternative solvent/binder package mixture, and mixing the first mixture to produce a conductive additive mixture. Further, the method may include the step of preparing a second mixture comprising the one or more alternative solvents, the one or more solvent-soluble binders to form an alternative solvent/binder package, a cathode active material (CAM), and a solvent-insoluble binder, and mixing the second mixture to produce a conductive active material mixture. The method may include then combining the first mixture and the second mixture to form a homogenous cathode slurry. In some embodiments, the first binder package and the second binder package are mixed in a single, combined mixture, as opposed to mixing the first binder package and the second binder package in two or more discrete mixtures. As disclosed herein. In some embodiments, the first mixture and the second mixture are prepared as discrete mixtures and then combined. In other embodiments, the first mixture and the second mixture are prepared as a single mixture with all components.

In some embodiments, the first binder package may be specifically tailored to the dispersion and support needs of conductive additive while the second binder package may be tailored to the dispersion and support needs of cathode active material (CAM) 105. In some embodiments, the first binder package and the second binder package may be entirely different from one another. In other embodiments, the first binder package and the second binder package may be generally identical. In some embodiments, the first binder package may contain a singular component, low molecular weight, soluble binder such as PVP which allows for efficient mixing and stabilization of the conductive additive.

In some embodiments, the second binder package may contain an identical or non-identical soluble polymer binder to the first binder package with similar or differing molecular weight, specifically tailored to support the much more dense and large particles of catheter active material within the alternative solvent. For example, for PDO as the alternative solvent, generally higher molecular weight polymers will better support a denser material.

In some embodiments, the first binder package and/or the second binder package may further contain an insoluble polymer binder emulsion such as styrene butadiene rubber (SBR) or polyvinylidene fluoride (PVDF). Such an insoluble binder in emulsion form may be referred to as a “discrete” binder.

In some embodiments, the addition of the discrete or soluble binders may occur after the initial dispersion of conductive additive or CAM with soluble binders, and at a relatively slower mixing speed, to prevent agglomeration of materials with the discrete binders. For each mixture, the individual slurry viscosity, stability, homogeneity, and solids content may all be optimized and fine-tuned prior to final combination of mixtures to produce cathode slurry.

In some embodiments, the first binder package and/or the second binder package may comprise a polymeric binder dissolvable in the alternative solvent. In non-limiting examples, for example when PDO is used as the alternative solvent, the polymeric binder may be polyvinylpyrrolidone (PVP) or polyacrylic acid (PAA), an insoluble binder in an emulsion form, such as styrene butadiene rubber (SBR) or polyvinylidene fluoride (PVDF) nanoparticles, or a combination of the two, such as a soluble PVP mixed with an insoluble emulsion of PVDF.

In some embodiments, the first binder package and the second binder package may be in the form of particulates or particles. The binder particles in one or more of the first binder package and/or the second binder package may have a range of sizes or may be close in size. The binder particles in the first binder package and/or the second binder package may have a D50 size range of 200 nm to 10 μm as a macro-emulsion (or may be about 3 μm), a D50 size range of 50 to 200 nm as a mini emulsion (or may be about 100 nm), or less than 50 nm as a micro emulsion (or may be about 25 nm).

In some embodiments, the composition of the first binder package is the same as the composition of the second binder package. In some embodiments, the first binder package and the second binder package may include at least two components with differing compositions. For example, the first binder package and/or the second binder package may include one or more of PVP, PVA, PAA, polymethyl methacrylate (PMMA), polymethacrylic acid (PMA), polyethyl acrylate, polyvinyl acetate, polyvinylpyrrolidone-co-vinyl acetate (PVP-VA), polystyrene-co-styrenesulfonic acid (95:5) sodium salt, and cellulosic derivatives of lower molecular weight carboxymethyl cellulose (CMC) or other cellulosic polymers including but not limited to hydroxypropylmethyl cellulose (HPMC).

In some embodiments, the first binder package may contain more than one soluble binder, where each binder may have different or identical chemical structure and may have different or identical molecular weights. The first binder package may comprise polymers specific to stabilizing the conductive additive similar in function to a surfactant, whereas the other polymer, or polymers, would improve features such as viscosity modification or surface tension. In some embodiments, the conductive mixture undergoes high shear and high energy mixing to properly disperse the conductive additive and yield a monodisperse or monomodal particle size distribution (PSD) to ensure conductive additives are not agglomerated in suspension.

In some embodiments, the second binder package may contain at least one identical soluble polymer binder to the first binder package with similar or differing molecular weight and further contain one more binders that may have identical chemical composition and further differing molecular weight, or one or more binders that have differing chemical composition. In some embodiments, the one or more solvents used in the first mixture are the same as the one or more solvents used in the second mixture. In some embodiments, the one or more solvents used in the first mixture are different than the one or more solvents used in the second mixture.

As disclosed herein, in some embodiments, the first binder package and/or the second binder package may further contain a discrete, insoluble polymer binder emulsion such as styrene butadiene rubber (SBR) or polyvinylidene fluoride (PVDF). In some embodiments, the addition of the discrete or soluble binders may occur after the initial dispersion of conductive additive or cathode active material (CAM) with soluble binders, and at a relatively slower mixing speed, to prevent agglomeration of materials with the discrete binders. For each of the mixtures, the individual slurry viscosity, stability, homogeneity, and solids content may all be optimized and fine-tuned prior to final combination of mixtures to produce cathode slurry.

The conductive mixture 106 and cathode active material mixture 107 may be mixed in a benchtop double planetary, high shear, contactless/bladeless mixer such as a Thinky mixer, FLAKTEK, or Hauschild Speedmixer model. In some embodiments, mixing may be performed on larger scales including pilot scale, small production scale, and large production scale with planetary and rotary blade mixers (also referred to as double planetary and dispersing mixers respectively) such as models from Ross, Siehe, Ongoal, Jamieson, or others. In some examples, mixing may be conducted in vessels from 10 mL to 100 mL, 100 mL to 300 mL, 300 mL to 500 mL, and 500 mL to 750 mL in volume, which constitutes mixing at the benchtop scale. In other examples, mixing may be conducted in vessels from 750 mL to 2 L, 2 L to 10 L, 20 L to 25 L, and 50 L to 125 L in volume, which constitutes mixing at the pilot scale. In further examples, mixing may be conducted in vessels from 125 L to 500 L, 500 L to 1000 L and 1000 L to 5000 L in volume, which constitutes mixing at both the small and large production scales. In some examples, mixing may be conducted for 1 min, 5 min, 10 min, 30 min, 60 min, 90 min, or 120 min. In some embodiments, mixing may be conducted at 1000 RPM, 1500 RPM, 2000 RPM, 2500 RPM, or 3000 RPM for benchtop double planetary, high shear, contactless/bladeless mixers. In some embodiments, mixing may be conducted at 1000 RPM, 1500 RPM, 2000 RPM, 2500 RPM, 3000 RPM, 3500 RPM, 4000 RPM, or 4000 RPM to 7000 RPM for high shear, rotary disperser type mixers, at the pilot and production scales. In some embodiments, mixing may be conducted at 10 RPM to 50 RPM, 50 RPM to 100 RPM, 100 RPM to 200 RPM, or 200 RPM to 500 RPM for double planetary, high torque, dual blade mixers at the pilot and production scales. In further embodiments, multiple types of mixers may be used simultaneously at the pilot and production scales. In some examples, the combination of high shear, high speed, rotary disperser mixing blades may be contained in the same mixing machine as the double planetary, high torque, dual blade mixer, and operated simultaneously. In a mixer with multiple mixing blades of different types, a combination of mixing RPM may be appropriately used. In some examples, such a combination mixer may conduct mixing with the double planetary, high torque, dual blades (referred to herein as double planetary blades) operating at 10 RPM to 50 RPM, 50 RPM to 100 RPM, 100 RPM to 200 RPM, or 200 RPM to 500 RPM while the high shear, high speed, rotary disperser mixing blades (referred to herein as disperser blades) may simultaneously operate at 1000 RPM, 1500 RPM, 2000 RPM, 2500 RPM, 3000 RPM, 3500 RPM, 4000 RPM, or 4000 RPM to 7000 RPM. In other embodiments, a combination mixer may operate with one or both of the double planetary or disperser blades operating simultaneously or one at a time. A type of container and process of mixing used is not limited and is variable according to the operator and known to those skilled in the art. Mixing parameters may be varied to tailor to the specific needs of the materials chosen in conductive mixture 106 and CAM mixture 107.

In some embodiments, the first binder package 102 and the second binder package may contain components of varying molecular weight such that the first binder package and the second binder package vary in molecular weight. For example, the first binder package may include two binders with different molecular weights: a low molecular weight binder (for dispersion of the conductive additive, for example) and a high molecular weight binder (as a thickener for improving slurry stability and/or an adhesion promoter for improving coating quality), where the low molecular weight binder may have a lower molecular weight than the high molecular weight binder. In some examples, the molecular weight of the low molecular weight binder may be between 5,000 and 120,000 Da or between 25,000 and 850,000 Da. In some examples, the molecular weight of the high molecular weight binder may be between 200,000 and 850,000 Da or between 450,000 and 1,000,000 Da. In some embodiments, two binders may be combined that have identical chemical composition but only vary in molecular weight in which one molecular weight is higher than the other. For example, low molecular weight and high molecular weight PAA or PVP may be combined. In other embodiments, the low molecular weight binder and the high molecular weight binder may have different compositions.

In some embodiments, the cathode slurry 108 may have a dynamic viscosity of at least 10,000 cP at 85 s-1. In some examples, the viscosity may be between 10,000 cP and 200,000 cP. In other embodiments, the viscosity may depend upon the solids content of the cathode slurry and/or a composition of the cathode active material. As a result, greater control may be afforded over various coating parameters and rheological properties of the cathode slurry 108.

In some embodiments, the cathode slurry may have a solids content of 10-90% solids, 20-80% solids, 30-70% solids, or 40-60% solids. In some embodiments, the cathode slurry 108 may have solids content of 10-50% solids, 10-40% solids, 10-30% solids, 10-20% solids, or 5-10% solids. In some embodiments, the cathode slurry may have solids content of 60-95% solids, 70-95% solids, 80-95% solids, or 90-95% solids.

As disclosed herein, exemplary embodiments for methods for preparing a cathode slurry composition include two processing routes in which two different mixtures are made and combined to prepare the final slurry. This is advantageous as preparing two mixtures avoids gelation and provides good results at lab scale. However, it is noted that the alternative solvents identified herein and used for preparing a lithium-ion battery electrode may be used with a single mixture of one or more binder packages, conductive additives, and cathode active material.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A cathode slurry composition comprising:
one or more mixtures comprising:
one or more polar organic solvents;
a conductive additive;
a lithium-containing cathode active material (CAM);
one or more solvent-soluble binders, dissolved in the one or more polar organic solvents; and
nanoparticles formed from a solvent-insoluble, discrete binder, wherein the nanoparticles are dispersed within the one or more polar organic solvents as a miniemulsion having a particle size of about 10 nm to about 200 nm.

2. The composition of claim 1, wherein the one or more polar organic solvents is selected from the group consisting of 1,3-propanediol (PDO), dimethyl sulfoxide (DMSO), dimethylformamide (DMF), dihydrolevoglucosenone (Cyrene), N,N′-dimethylpropyleneurea (DMPU), γ-valerolactone (GVL), 1,2-propanediol (propylene glycol or PG), 1,2-butanediol (BDO), 1,3-butanediol (butylene glycol or BG), 1,2-hexanediol (HDO), triethyl phosphate (TEP), ethyl acetate, propyl acetate, 1-butanol, isobutanol, ethanol, propylene carbonate (PC), and combinations thereof.

3. The composition of claim 1, wherein the one or more solvent-soluble binders are one or more a water-soluble polymers.

4. The composition of claim 2, wherein the one or more polar organic solvents comprises 1,3-propanediol (PDO).

5. The composition of claim 4, wherein the one or more solvent-soluble binders comprises polyvinylpyrrolidone (PVP) or polyacrylic acid (PAA), and the solvent-insoluble discrete binder comprises styrene-butadiene rubber (SBR) or polyvinylidene fluoride (PVDF).

6. The composition of claim 5, wherein the one or more solvent-soluble binders is a combination of PAA and PVP, and the solvent-insoluble discrete binder is a combination of SBR and PVDF.

7. The composition of claim 1, wherein the CAM comprises one or more of a lithium intercalating material, lithium nickel cobalt manganese oxide (NCM), lithium nickel cobalt aluminum oxide (NCA), lithium cobalt oxide (LCO), lithium manganese oxide (LMO), lithium iron phosphate (LFP), and lithium iron manganese phosphate (LMFP).

8. The composition of claim 1, wherein the conductive additive is one or more of amorphous carbon, graphene, carbon nanotubes, porous carbon, and carbon black.

9. The composition of claim 1, wherein in the one or more mixtures comprises:
a first mixture comprising the one or more polar organic solvents, the one or more solvent-soluble binders, and the conductive additive; and
a second mixture comprising the one or more solvents, the one or more solvent-soluble binders, the lithium-containing cathode active material (CAM), and the nanoparticles formed from the solvent-insoluble, discrete binder.

10. The composition of claim 9, wherein the one or more solvent-soluble binders in the first mixtures is the same as the one or more solvent-soluble binders in the second mixture.

11. The composition of claim 10, wherein the one or more solvent-soluble binders in the first mixture is different than the one or more solvent-soluble binders in the second mixture.

12.-23. (canceled)

24. A method for manufacturing a lithium-ion battery electrode comprising:
preparing one or more mixtures comprising:
one or more polar organic solvents;
one or more solvent-soluble binders, dissolved in the one or more solvents;
a conductive additive;
a cathode active material (CAM); and
a solvent-insoluble binder package comprising nanoparticles of a solvent-insoluble discrete binder, wherein the nanoparticles are dispersed within the one or more polar organic solvents as a miniemulsion having a particle size of about 10 nm to about 200 nm to form a cathode slurry composition;
coating the cathode slurry onto a current collector to form a cathode coating; and
drying and calendaring the cathode coating to a target thickness and porosity upon drying to thereby fabricate a lithium-ion battery electrode.

25. The method of claim 24, wherein the one or more solvents is selected from the group consisting of: 1,3-propanediol (PDO), dimethyl sulfoxide (DMSO), dimethylformamide (DMF), dihydrolevoglucosenone (Cyrene), N,N′-dimethylpropyleneurea (DMPU), γ-valerolactone (GVL), 1,2-propanediol (propylene glycol or PG), 1,2-butanediol (BDO), 1,3-butanediol (butylene glycol or BG), 1,2-hexanediol (HDO), triethyl phosphate (TEP), ethyl acetate, propyl acetate, 1-butanol, isobutanol, ethanol, propylene carbonate (PC), and combinations thereof.

26. The method of claim 24, wherein the one or more solvent-soluble binders are one or more water soluble polymers.

27. The method of claim 25, wherein the solvent comprises 1,3-propanediol (PDO).

28. The method of claim 27, wherein the one or more solvent-soluble binders is selected from the group consisting of polyvinylpyrrolidone (PVP), polyacrylic acid (PAA), and combinations thereof, and the solvent-insoluble discrete binder is selected from the group consisting of styrene-butadiene rubber (SBR), polyvinylidene fluoride (PVDF), and combinations thereof.

29. (canceled)

30. The method of claim 24, wherein the CAM comprises one or more of a lithium intercalating material, lithium nickel cobalt manganese oxide (NCM), lithium nickel cobalt aluminum oxide (NCA), lithium cobalt oxide (LCO), lithium manganese oxide (LMO), lithium iron phosphate (LFP), and lithium iron manganese phosphate (LMFP).

31. The method of claim 24, wherein the conductive additive is one or more of amorphous carbon, graphene, carbon nanotubes, porous carbon, and carbon black.

32. The method of claim 24, wherein preparing the one or more mixtures comprises:
forming a first binder package comprising the one or more polar organic solvents and a first group of one or more solvent-soluble binders;
preparing a first mixture comprising the first binder package and the conductive additive;
forming a second binder package comprising the one or more polar organic solvents and a second group of the one or more solvent-soluble binders;
preparing a second mixture comprising the cathode active material (CAM), and the solvent-insoluble binder package; and
combining the first mixture with the second mixture to form a cathode slurry composition.

33.-34. (canceled)

35. The method of claim 32, wherein the first group of one or more solvent-soluble binders has a higher average molecular weight than the second group of one or more solvent-soluble binders.

36.-48. (canceled)
